(19) United States
(12) Patent Application Publication
(10) Pub. No.: US 2015/0200962 A1
(43) Pub. Date: Jul. 16, 2015

(54) METHOD AND SYSTEM FOR RESILIENT AND ADAPTIVE DETECTION OF MALICIOUS WEBSITES

(71) Applicant: The Board of Regents of the University of Texas System, Austin, TX (US)

(72) Inventors: Shouhuai Xu, Helotes, TX (US); Li Xu, San Antonio, TX (US); Zhenxin Zhan, San Antonio, TX (US); Keying Ye, San Antonio, TX (US); Keesook Han, Rome, NY (US); Frank Born, Rome, NY (US)

(21) Appl. No.: 14/405,553

(22) PCT Filed: Jun. 4, 2013
(86) PCT No.: PCT/US2013/044063

§ 371 Date: Dec. 4, 2014

Related U.S. Application Data
(60) Provisional application No. 61/655,030, filed on Jun. 4, 2012.

(51) Int. Cl. H04L 29/06

(52) U.S. Cl. CPC H04L 63/1483; H04L 63/1491

(57) ABSTRACT

A computer-implemented method for detecting malicious websites includes collecting data from a website. The collected data includes application-layer data of a URL, wherein the application-layer data is in the form of feature vectors; and network-layer data of a URL, wherein the network-layer data is in the form of feature vectors. Determining if a website is malicious based on the collected application-layer data vectors and the collected network-layer data vectors.

### STATEMENT REGARDING FEDERALLY SPONSORED RESEARCH OR DEVELOPMENT

This invention was made with government support from the Air Force Office of Scientific Research (AFSOR), Grant number FA9550-09-1-0165. The U.S. Government has certain rights to this invention.

### BACKGROUND OF THE INVENTION

1. Field of the Invention

The invention generally relates to systems and methods of detecting malicious websites.

2. Description of the Relevant Art

Malicious websites have become a severe cyber threat because they can cause the automatic download and execution of malware in browsers, and thus compromise vulnerable computers. The phenomenon of malicious websites will persevere at least in the near future because we cannot prevent websites from being compromised or abused. Existing approaches to detecting malicious websites can be classified into two categories: the static approach and the dynamic approach.

The static approach aims to detect malicious websites by analyzing their URLs or their contents. This approach is very efficient and thus can scale up to deal with the huge population of websites in cyberspace. This approach however has trouble coping with sophisticated attacks that include obfuscation, and thus can cause high false-negative rates by classifying malicious websites as benign ones.

The dynamic approach aims to detect malicious websites by analyzing their run-time behavior using Client Honeypots or their like. Assuming the underlying detection is competent, this approach is very effective. This approach however is resource consuming because it runs or emulates the browser and possibly the operating system. As a consequence, this approach cannot scale up to deal with the large number of websites in cyberspace.

Because of the above, it has been advocated to use a front-end light-weight tool, which is mainly based on static analysis and aims to rapidly detect suspicious websites, and a back-end more powerful but much slower tool, which conducts a deeper analysis of the detected suspicious websites. While conceptually attractive, the success of this hybrid approach is fundamentally based on two hypotheses.

The first hypothesis is that the front-end static analysis must have very low false-negatives; otherwise, many malicious websites will not be detected even with powerful back-end dynamic analysis tools. In real life, the attacker can defeat pure static analysis by exploiting various sophisticated techniques such as obfuscation and redirection.

The second hypothesis is that the classifiers (i.e. detection models) learned from past data are equally applicable to future attacks. However, this cannot be taken for granted because the attacker can get the same data and therefore use the same machine learning algorithms to derive the defender's classifiers. This is plausible because in view of Kerckhoffs's Principle in cryptography, we should assume that the defender's learning algorithms are known to the attacker. As a consequence, the attacker can always act one step ahead of the defender by adjusting its activities so as to evade detection.

An inherent weakness of the static approach is that the attacker can adaptively manipulate the contents of malicious websites to evade detection. The manipulation operations can take place either during the process of, or after, compromising the websites. This weakness is inherent because the attacker controls the malicious websites. Furthermore, the attacker can anticipate the machine learning algorithms the defender would use to train its detection schemes (e.g., J48 classifiers or decision trees), and therefore can use the same algorithms to train its own version of the detection schemes. In other words, the defender has no substantial “secret” that is not known to the attacker. This is in sharp contrast to the case of cryptography, where the defender's cryptographic keys are not known to the attacker. It is the secrecy of cryptographic keys (as well as the mathematical properties of the cryptosystem in question) that allows the defender to defeat various attacks.

### SUMMARY OF THE INVENTION

Malicious websites have become a major attack tool of the adversary. Detection of malicious websites in real time can facilitate early-warning and filtering the malicious website traffic. There are two main approaches to detecting malicious websites: static and dynamic. The static approach is centered on the analysis of website contents, and thus can automatically detect malicious websites in a very efficient fashion and can scale up to a large number of websites. However, this approach has limited success in dealing with sophisticated attacks that include obfuscation. The dynamic approach is centered on the analysis of website contents via their nm-time behavior, and thus can cope with these sophisticated attacks. However, this approach is often expensive and cannot scale up to the magnitude of the number of websites in cyberspace.

These problems may be addressed using a novel cross-layer solution that can inherit the advantages of the static approach while overcoming its drawbacks. The solution is centered on the following: (i) application-layer web contents, which are analyzed in the static approach, may not provide sufficient information for detection; (ii) network layer traffic corresponding to application-layer communications might provide extra information that can be exploited to substantially enhance the detection of malicious websites.

A cross-layer detection method exploits the network-layer information to attain solutions that (almost) can simultaneously achieve the best of both the static approach and the dynamic approach. The method is implemented by first obtaining a set of websites as follows. URLs are obtained from blacklists (e.g., malwaredomainlist.com and malware.com.br). A client honeypot (e.g., Capture-HPC (ver 3.0)) is used to test whether these blacklisted URLs are still malicious; this is to eliminate the blacklisted URLs that are cured or taken offline already. Their benign websites are based on the top ones listed by alexa.com, which are supposedly better protected.

A web crawler is used to fetch the website contents of the URLs while tracking several kinds of redirects that are identified by their methods. The web crawler also queries the Whois, Geographic Service and DNS systems to obtain information about the URLs, including the redirect URLs that are collected by the web crawler. In an embodiment, the web crawler records application-layer information corresponding to the URLs (i.e., website contents and the information that can be obtained from Whois etc.), and network-layer traffic that corresponds to all the above activities (i.e., fetching HTTP contents, querying Whois etc.). In principle, the network-layer data can expose some extra information about the malicious websites. The collected application-layer and network-layer data is used to train a cross-layer detection scheme in two fashions. In data-aggregation cross-layer detection, the application-layer and network-layer data corresponding to the same URL are simply concatenated together to represent the URL for training or detection. In XOR-aggregation cross-layer detection, the application-layer data and the network-layer data are treated separately: a website is determined as malicious if both the application-layer and network-layer detection schemes say it is. If only one of the two detection schemes says the website is malicious, the website is analyzed by the backend dynamic analysis (e.g., client honeypot).

In an embodiment, a model of adaptive attacks is produced. The model accommodates attacker's adaptation strategies, manipulation constraints, and manipulation algorithms. Experiments based on a dataset of 40 days show that adaptive attacks can make malicious websites easily evade both single- and cross-layer detections. Moreover, we find that the feature selection algorithms used by machine learning algorithms do not select features of high security significance. In contrast, the adaptive attack algorithms can select features of high security significance. Unfortunately, the “black-box” nature of machine learning algorithms still makes it difficult to explain why some features are more significant than others from a security perspective.

Proactive detection schemes may be used to counter adaptive attacks, where the defender proactively trains its detection schemes. Experiments show that the proactive detection schemes can detect manipulated malicious websites with significant success. Other findings include: (i) The defender can always use proactive detection without worrying about the side-effects (e.g., when the attacker is not adaptive). (ii) If the defender does not know the attacker's adaptation strategy, the defender should adopt a full adaptation strategy, which appears (or is close) to be a kind of equilibrium strategy.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

As used herein the terms “web crawler” or “crawler” refer to a software application that automatically and systematically browses the World Wide Web and runs automated tasks over the Internet.

As used herein the term “application layer” refers to the OSI Model layer 7. The application layer supports application and end-user processes. This layer provides application services for file transfers, e-mail, and other network software services.

As used herein the term “network layer” refers to the OSI Model layer 3. This layer provides switching and routing technologies, creating logical paths, known as virtual circuits, for transmitting data from node to node. Routing and forwarding are functions of this layer, as well as addressing, internetworking, error handling, congestion control and packet sequencing.

There are at least 105 application-layer features and 19 network-layer features that we have identified for use in malicious website detection. It was found, however, that only 15 application-layer features (A1-A15) and 9 network-layer features (N1-N9) are necessary for efficient malicious website detection. Specific features used are listed below:

### Application Layer Features

(A1) URL_length: the length of a website URL in question.
(A2) Protocol: the protocol for accessing (redirect) websites (e.g., http, https, ftp).
(A3) Content_length: the content-length field in HTTP header, which may be arbitrarily set by a malicious website to not match the actual length of the content.
(A4) RegDate: website's registration date at Whois service.
(A5-A7) Country, Stateprov and Postalcode: country, state/province and postal code of a website when registered at Whois service.
(A8) #Redirect: number of redirects incurred by an input URL.
(A9) #Scripts: number of scripts in a website (e.g., JavaScript).
(A10) #Embedded_URL: number of URLs embedded in a website.
(A11) #Special_character: number of special characters (e.g., ?, −, _, =, %) contained in a URL.
(A12) Cache_control: webserver cache management method.
(A13) #Iframe: number of iframes in a website.
(A14) #JS_function: number of JavaScript functions in a website.
(A15) #Long_string: number of long strings (length>50) used in embedded JavaScript programs.

### Network Layer Features

(N1) #Src_app_bytes: bytes of crawler-to-website communications.
(N2) #Local_app_packet: number of crawler-to-website IP packets communications, including redirects and DNS queries.
(N3) Dest_app_bytes: volume of website-to-crawler communications (i.e., size of website content etc.).
(N4) Duration: duration time between the crawler starts fetching a website contents and the crawler finishes fetching the contents.
(N5-N6) #Dist_remote_tcp_port and #Dist_remote_IP: number of distinct TCP ports and IP addresses the crawler uses to fetch websites contents (including redirect), respectively.
(N7) #DNS_query: number of DNS queries issued by the crawler (it can be multiple because of redirect).
(N8) #DNS_answer: number of DNS server's responses.
(N9) App_bytes: bytes of the application-layer data caused by crawler webserver two-way communications.
Metrics. To evaluate the power of adaptive attacks and the effectiveness of proactive detection against adaptive attacks, we mainly use the following metrics: detection accuracy, trust-positive rate, false-negative rate, and false-positive rate.

Let D_{α}=D_{α}.malicious∪D_{α}.benign be a set of feature vectors that represent websites, where D_{α}.malicious represents the malicious websites and D_{α}.benign represents the benign websites. Suppose a detection scheme (e.g., J48 classifier) detects malicious⊂D_{α}.malicious as malicious websites and benignøD_{α}.benign as benign websites.

Detection accuracy is defined as:

$$\frac{\vert malicious ⋃ benign \vert}{{D}_{α} \cdot benign}$$

True-positive rate is defined as:

$$TP = \frac{\vert malicious \vert}{{D}_{α} \cdot malicious}$$

False negative rate is defined as:

$$TN = \frac{\vert {D}_{α} \cdot malicious \backslash malicious \vert}{{D}_{α} \cdot malicious}$$

False positive rate is defined as:

$$FP = \frac{\vert {D}_{α} \cdot benign \backslash benign \vert}{{D}_{α} \cdot benign}$$

Note that TP+FN=1, but we use both for better exposition of results.

### Notations

The main notations are summarized as follows:
“MLA”—machine learning algorithm;
“fv”—feature vector representing a website (and its redirects);
X_{Z}—feature X_{z}'s domain is [min_{z}, max_{z}];
M₀, . . . , M_{γ}—defender's detection schemes (e.g., J48 classifier);
D′₀—training data (feature vectors) for learning M₀;
D₀−D₀=D₀.malicious∪D₀.benign, where malicious feature vectors in D₀.malicious may have been manipulated;
D₀^{†}—feature vectors used by defender to proactively train M₁, . . . , M_{γ};
   D₀^{†}=D₀^{†}.malicious∪D₀^{†}.benign
Mᵢ(D_{α})—applying detection scheme Mᵢ to feature vectors D_{α}
M_{0-γ}(D_{α})—majority vote of M₀(D_{α}), M₁(D_{α}), . . . M_{γ}D_{α}
T, C, F—adaptation strategy ST, manipulation algorithm F, manipulation constraints
s [symbol] S—assigning s as a random member of set S;
υ−υ is a node on a J48 classifier (decision tree), υ.feature is the feature associated to node υ and υ.value is the “branching” point of υ.feature's value on the tree.

In an embodiment, a method of detecting malicious websites analyzes the website contents as well as the redirection website contents in the fashion of the static approach, while taking advantage of the network-layer traffic information. More specifically, this method includes:
1. Using static analysis to proactively track redirections, which have been abused by the attacker to hide or obfuscate malicious websites. This type of static analysis can be extended to track redirections and detect many malicious websites.
2. Exploiting the network-layer traffic information to gain significant extra detection capabilities. A surprising finding is that even though there are more than 120 cross-layer features, using only 4 application-layer features and 9 network-layer features in the learning process will lead to high detection accuracy.

The method can be made resilient to certain classes of adaptive attacks. This is true even if a few features are used.

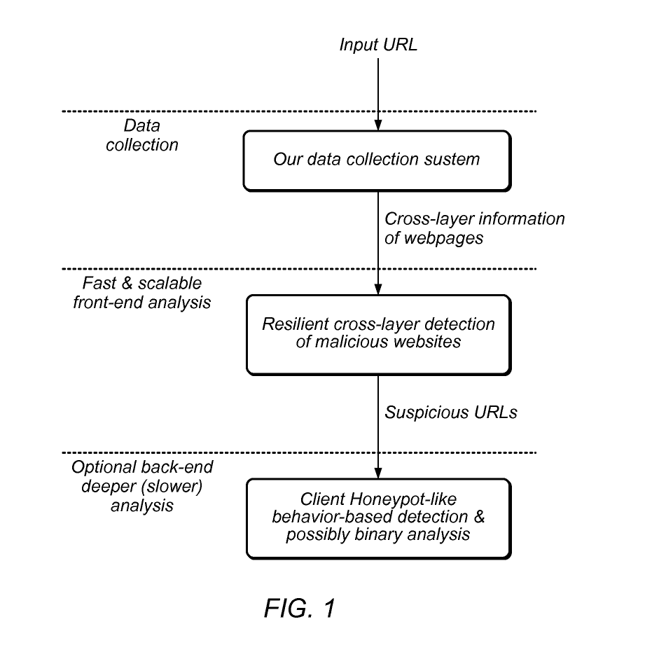

FIG. 1 depicts a schematic diagram of a method of detecting malicious websites. The includes a data collection component, a detection system for determining if a website is malicious, and an optional dynamic analyzer for further analysis of detected malicious websites.

The Open Systems Interconnection model (“OSI model”) defines a networking framework to implement protocols in seven layers. Control is passed from one layer to the next is a predefined order. The seven layers of the OSI model include: Application (Layer 7); Presentation (Layer 6); Session (Layer 5); Transport (Layer 4); Network (Layer 3); Data Link (Layer 2); and Physical (Layer 1).

### A. Cross-Layer Data Collection and Pre-Processing

### 1. Data Collection Method and System Architecture

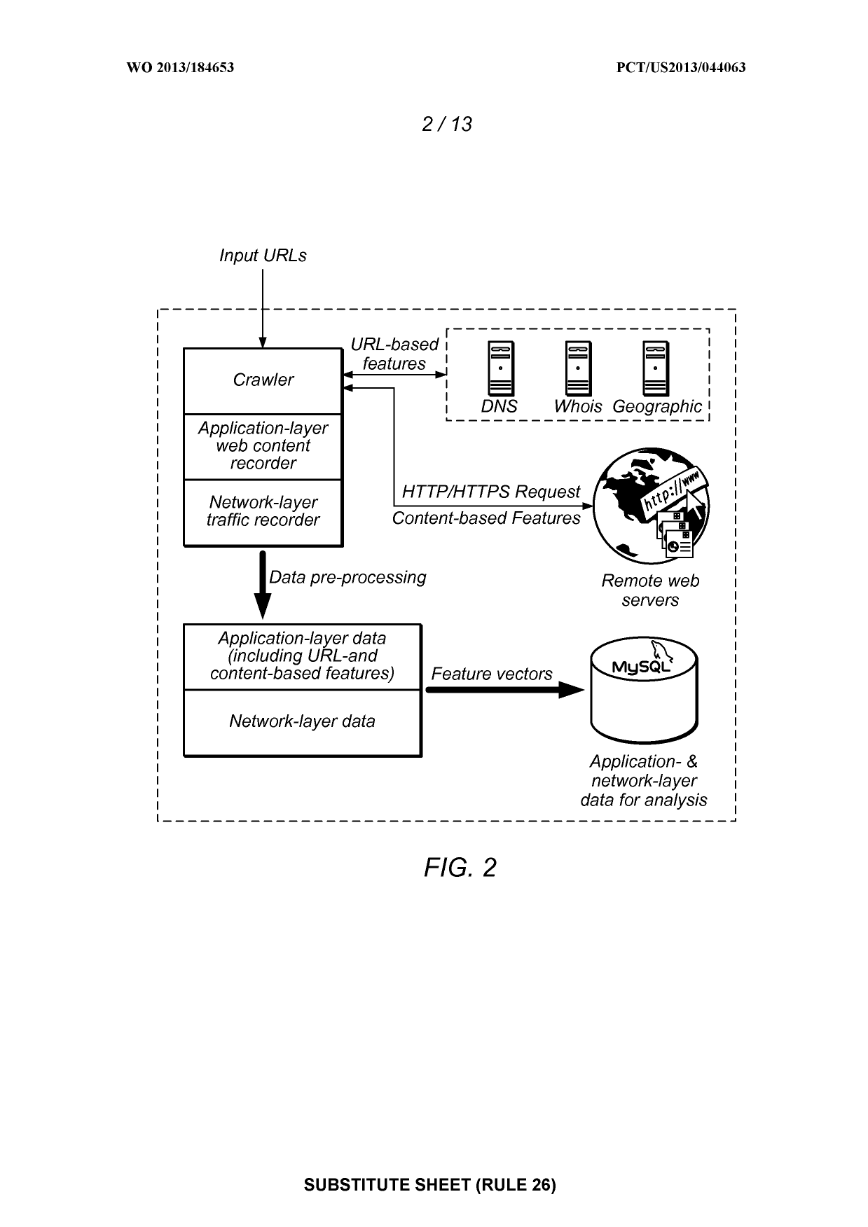

In order to facilitate cross-layer analysis and detection, an automated system is configured to collect both the application layer communications of URL contents and the resulting network-layer traffic. The architecture of the automated data collection system is depicted in FIG. 2. At a high-level, the data collection system is centered on a crawler, which takes a list of URLs as input, automatically fetches the website contents by launching HTTP/HTTPS requests to the target URLs, and tracks the redirects it identified from the website contents (elaborated below). The crawler further uses the URLs, including both the input one and the resulting redirects, to query the DNS, Whois, Geographic services for collecting relevant features for analysis. The application layer web contents and the corresponding network-layer IP packets are recorded separately, but are indexed by the input URLs to facilitate cross-layer analysis. The collected application-layer raw data are pre-processed to make them suitable for machine learning tasks (also elaborated below).

### Statically Proactive Tracking of Redirects

The data collection system proactively tracks redirections by analyzing the website contents in a static fashion. This makes this method as fast and scalable as the static approach. Specifically, the method considers the following four types of redirections. The first type is server side redirects that are initiated either by server rules (i.e., .htaccess file) or server side page code such as php. These redirects often utilize HTTP 300 level status codes. The second type is JavaScript based redirections. Despite extensive study, there has been limited success in dealing with JavaScript-based redirection that is coupled with obfuscation. The third type is the refresh Meta tag and HTTP refresh header, which allow one to specify the URLs of the redirection pages. The fourth type is embedded file redirections. Examples of this type of redirections are: <iframe src=‘badsite.php’/>, <img src=‘badsite.php’/>, and <script src=‘badsite.php’><script>.

It is important to understand that the vast majority of malicious URLs are actually victim sites that have themselves been hacked. Sophos Corporation has identified the percentage of malicious code that is hosted on hacked sites as 90%. Most often this malicious code is implanted using SQL injection methods and shows up in the form of an embedded file as identified above. In addition, stolen ftp credentials allow hackers direct access to files where they can implant malicious code directly into the body of a web page or again as an embedded file reference. The value of the embedded file method to hackers is that, through redirections and changing out back end code and file references, they can better hide the malicious nature of these embedded links from search engines and browsers.

### Description and Pre-Processing of Application-Layer Raw Data

The resulting application-layer data have 105 features in total, which are obtained after pre-processing the collected application-layer raw data. The application-layer raw data consist of feature vectors that correspond to the respective input URLs. Each feature vector consists of various features, including information such as HTTP header fields; information obtained by using both the input URLs and the detected redirection URLs to query DNS name services, Whois services for gathering the registration date of a website, geographic location of a URL owner/registrant, and JavaScript functions that are called in the JavaScript code that is part of a website content. In particular, redirection information includes (i) redirection method, (ii) whether a redirection points to a different domain, (iii) the number of redirection hops.

Because different URLs may involve different numbers of redirection hops, different URLs may have different numbers of features. This means that the application-layer raw feature vectors do not necessarily have the same number of features, and thus cannot be processed by both classifier learning algorithms and classifiers themselves. We resolve this issue by aggregating multiple-hop information into artificial single hop information as follows: for numerical data, we aggregate them by using their average instead; for boolean data, we aggregate them by taking the OR operation; for nominal data, we only consider the final destination URL of the redirection chain. For example, suppose that an input URL is redirected twice to reach the final destination URL and the features are (Content-Length, “Is JavaScript function eval( ) called in the code?”, Country). Suppose that the raw feature vectors corresponding to the input, first redirection, and second redirection URLs are (100, FALSE, US), (200, FALSE, UK), and (300, TRUE, RUSSIA), respectively. We aggregate the three raw feature vectors as (200, TRUE, RUSSIA), which is stored in the application-layer data for analysis.

### Description of Network-Layer Data

The network-layer data consist of 19 features, including: iat_flow, which is the accumulative inter-arrival time between the flows caused by the access to an input URL; dns_query_times, which is the total number of DNS queries caused by the access to an input URL; tcp_conversation_exchange which is the number of conversation exchanges in the TCP connections; ip_packets, which is the number of IP packets caused by the access to an input URL. Note that network-layer does not record information regarding redirection, which is naturally dealt with at the application-layer.

### B. Cross-Layer Data Analysis Methodology

### Classifier Accuracy Metrics

Suppose that the defender learned a classifier M from some training data. Suppose that the defender is given test data D, which consist of d₁ malicious URLs and d₂ benign URLs. Suppose further that among the d₁ malicious URLs, M correctly detected d′₁ of them, and that among the d₂ benign URLs, M correctly detected d′₂ of them. The detection accuracy or overall accuracy of M is defined as (d′₁+d′₂)/(d₁+d₂). The rate is defined as (d₂−d′₂)/d₂, the true-positive rate is defined as d′₁/d₁ and the false-negative rate is defined as (d₁−d′₁)/d₁. Ideally, we want a classifier to achieve high detection accuracy, low false-positive rate and low false-negative rate.

### Data Analysis Methodology

Our analysis methodology was geared towards answering questions about the power of cross-layer analysis. It has three steps, which are equally applicable to both application layer and network-layer data. We will explain the adaption that is needed to deal with cross-layer data.
1) Preparation: Recall that the collected cross-layer data are stored as feature vectors of the same length. This step is provided by the classifiers in the Weka toolbox, and resolves issues such as missing feature data and conversion of strings to numbers.
2) Feature selection (optional): Because there are more than 100 features, we may need to conduct feature selection. We used the following three feature selection methods. The first feature selection method is called CfsSubsetEval in the Weka toolbox. It essentially computes the features' prediction power, and its selection algorithm essentially ranks the features' contributions. It outputs a subset of features that are substantially correlated with the class (benign or malicious) but have low inter-feature correlations. The second feature selection method is called GainRatioAttributeEval in the Weka toolbox. Its evaluation algorithm essentially computes the information gain ratio (or more intuitively the importance of each feature) with respect to the class, and its selection algorithm ranks features based on their information gains. It outputs the ranks of all features in the order of decreasing importance. The third method is PCA (Principle Component Analysis) that transforms a set of feature vectors to a set of shorter feature vectors.
3) Model learning and validation: We used four popular learning algorithms: Naive Bayes, Logistic, SVM, and J48, which have been implemented in the Weka toolbox. Naive Bayes classifier is based on Bayes rule and assumes all the attributes are independence. Naive Bayes works very well when apply on spam classification. Logistic regression classifier is one kind of linear classification which builds a linear model based on a transformed target variable. Support vector machine (SVM) classifier are among the best sophisticated supervised learning algorithm. It tries to find a maximum-margin hyper plane to separate different classes in training data. Only a small number of boundary feature vectors, namely support vectors, will contribute to the final model. We use SMO (sequential minimal-optimization) algorithm in our experiment with polynomial kernel function, which gives an efficient implementation of SVM. J48 classifier is Weka implementation of C4.5 decision tree. It actually implements a revised version 8. We use pruned decision tree in our experiment.

For cross-layer data analysis, we consider the following two cross-layer aggregation methods.

1. Data-level aggregation. The application-layer feature vector and the network-layer feature vector with respect to the same URL are simply merged into a single longer feature vector. This is possible because the two vectors correspond to the same URL. In this case, the data-level aggregation operation is conducted before the above three-step process.
2. Model-level aggregation. The decision whether a website is malicious is based on the decisions of the application-layer classifier and the network-layer classifier. There are two options. One option is that a website is classified as malicious if the application layer classifier or the network-layer classifier says it is malicious; otherwise, it is classified as benign. We call this OR-aggregation. The other option is that a website is classified as malicious if both the application-layer classifier and the network-layer classifier say it is malicious; otherwise, it is classified as benign. We call this AND-aggregation. In this case, both application- and network-layer data are processed using the above three-step process. Then, the output classifiers are further aggregated using OR or AND operation.

### Datasets Description

Our dataset D consists of 1,467 malicious URLs and 10,000 benign URLs. The malicious URLs are selected out of 22,205 blacklisted URLs downloaded from http://compuweb.com/url-domain-bl.txt and are confirmed as malicious by high-interaction client honeypot Capture-HPC version 3.0. Our test of blacklisted URLs using high interaction client honeypot confirmed our observation that some or many blacklisted URLs are not accessible anymore and thus should not be counted as malicious URLs. The 10,000 benign URLs are obtained from alexa.com, which lists the top 10,000 websites that are supposed to be well protected.

### C. On the Power and Practicality of Cross-Layer Detection on the Power of Cross-Layer Detection

Because detection accuracy may be classifier-specific, we want to identify the more powerful classifiers. For this purpose, we compare the aforementioned four classifiers, with or without feature selection. Table I describes the results without using feature selection, using PCA feature selection, and using CfsSubsetEval feature selection. We make the following observations. First, for cross-layer detection, J48 classifier performs better than the other three classifiers. In particular, J48 classifiers in the cases of data-level aggregation and OR-aggregation lead to the best detection accuracy. J48 classifier in the case of data-level aggregation detection leads to the best false-negative rate. J48 classifier in the case of OR-aggregation leads to the best false-positive rate. J48 classifier in the case of AND aggregation naturally leads to the lowest false-positive rate, but also causes a relatively high false-negative rate.

TABLE I
COMPARISON (%) BETWEEN NO
FEATURE SELECTION AND TWO FEATURE SELECTION METHODS

| | Feature selection | Naive Bayes | | | Logistic | | | SVM | | | J48 | | |
|---|---|---|---|---|---|---|---|---|---|---|---|---|---|
| Layer | method | Acc. | FN | FP | Acc. | FN | FP | Acc. | FN | FP | Acc. | FN | FP |
| Application- | none | 98.54 | 11.31 | 0.01 | 99.87 | 0.27 | 0.1 | 98.92 | 7.43 | 0.13 | 98.99 | 7.63 | 0.03 |
| layer | PCA | 94.44 | 1.43 | 6.16 | 99.76 | 1.64 | 0.04 | 99.60 | 2.93 | 0.02 | 99.88 | 0.68 | 0.03 |
| | CfsSubsetEval | 98.45 | 4.23 | 1.16 | 99.81 | 1.30 | 0.03 | 66.69 | 2.38 | 0.0 | 99.80 | 1.29 | 0.03 |
| Network- | none | 98.60 | 1.91 | 1.32 | 99.90 | 0.61 | 0.03 | 99.75 | 1.90 | 0.0 | 99.91 | 0.47 | 0.03 |
| layer | PCA | 78.09 | 55.94 | 9.39 | 79.94 | 58.09 | 6.07 | 78.44 | 69.69 | 3.85 | 94.88 | 9.32 | 3.57 |
| | CfsSubsetEval | 77.86 | 72.25 | 3.71 | 80.88 | 56.89 | 5.23 | 77.56 | 79.48 | 1.46 | 95.71 | 6.77 | 3.38 |
| Cross-layer | none | 99.75 | 1.84 | 0.01 | 99.79 | 0.74 | 0.12 | 99.78 | 1.70 | 0.0 | 99.91 | 1.47 | 0.03 |
| (data-level | PCA | 87.32 | 24.47 | 10.94 | 99.61 | 1.29 | 0.25 | 99.41 | 4.49 | 0.01 | 99.94 | 0.06 | 0.05 |
| agg.) | CfsSubsetEval | 98.44 | 4.22 | 1.16 | 99.80 | 1.29 | 0.03 | 99.69 | 2.38 | 0.0 | 99.80 | 1.29 | 0.03 |
| Cross-layer | none | 98.65 | 1.50 | 1.33 | 99.89 | 0.00 | 0.13 | 99.63 | 1.91 | 0.14 | 99.89 | 0.48 | 0.06 |
| (OR- | PCA | 85.82 | 1.43 | 16.05 | 99.28 | 1.64 | 0.59 | 98.97 | 2.93 | 0.75 | 99.92 | 0.00 | 0.09 |
| aggregation) | CfsSubsetEval | 97.97 | 1.23 | 2.15 | 98.63 | 1.30 | 1.38 | 97.61 | 2.39 | 2.39 | 98.97 | 1.30 | 0.99 |
| Cross-layer | none | 98.50 | 11.72 | 0.00 | 99.89 | 0.89 | 0.00 | 99.05 | 7.43 | 0.00 | 99.02 | 7.63 | 0.00 |
| (AND- | PCA | 91.83 | 58.55 | 0.78 | 98.93 | 8.38 | 0.00 | 98.91 | 8.52 | 0.00 | 99.81 | 1.50 | 0.00 |
| aggregation) | CfsSubsetEval | 98.67 | 10.43 | 0.00 | 99.05 | 7.43 | 0.00 | 95.13 | 38.10 | 0.00 | 99.05 | 7.43 | 0.00 |

(ACC.: DETECTION ACCURACY;
FN: FALSE-NEGATIVE RATE;
FP: FALSE-POSITIVE RATE).

Second, cross-layer detection can achieve best combination of detection accuracy, false positive rate and false negative rate. For each classifiers with or without feature selection method, comparing with either application-level or network-layer detection, data-level aggregation and OR aggregation cross-layer detection can hold higher detection accuracy (because the application- and network-layer classifier already reaches very high detection accuracy), low false negative rate, and low false-positive rate. Especially, data level aggregation and OR-aggregation cross-layer detection on J48 has obvious lower false negative. However, applying PCA feature selection on Naive Bayes has worse detection accuracy on data-level aggregation and OR-aggregation cross-layer detection. This gives us more reason using J48 in our experiment.

Third, given that we have singled out data-level aggregation and OR-aggregation cross-layer J48 classifier, let us now look at whether using feature selection will jeopardize classifier quality. We observe that using PCA feature selection actually leads to roughly the same, if not better, detection accuracy, false-negative rate, and false-positive rate. In the case of data-level aggregation, J48 classifier can be trained using 80 features that are derived from the 124 features using PCA; the CfsSubsetEval feature selection method actually leads to the use of four network-layer features: (1) local_app_bytes, which is the accumulated application bytes of TCP packets sent from local host to the remote server. (2) dist_remote_tcp_port, which is the accumulated TCP ports (distinct) that has been used by the remote server. (3) iat_flow, which is the accumulated inter-arrival time between flows. (4) avg_remote_rate, which is the rate the remote server sends to the victim (packets per second). This can be explained as follows: malicious websites that contain malicious code or contents can cause frequent and large volume communications between remote servers and local hosts.

In the case of OR-aggregation, J48 classifier can be trained using 74 application-layer features and 7 network-layer features, or 81 features that are derived from the 124 features using PCA; the CfsSubsetEval feature selection method actually leads to the use of five application-layer features and four network-layer features (the same as the above four involved in the case of data-level aggregation). This inspires us to investigate, in what follows, the following question: how few features can we use to train classifiers? The study will be based on the GainRatioAttributeEval feature selection method because it actually ranks the contributions of the individual features.

### On the Practicality of Using a Few Features for Learning Classifiers:

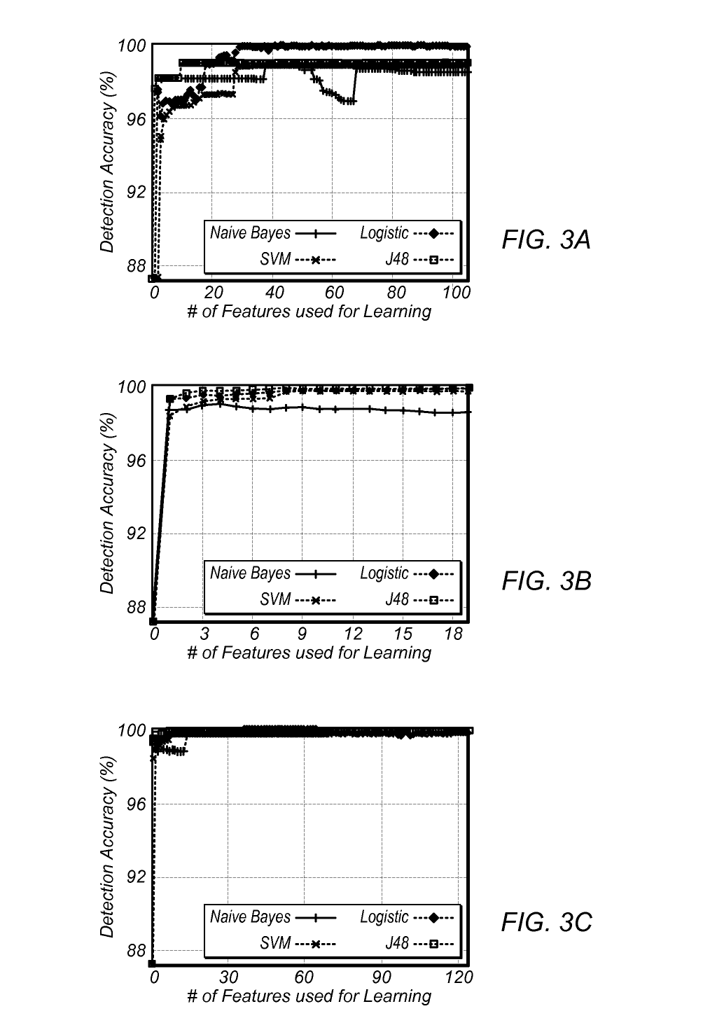

For GainRatioAttributeEval feature selection method, we plot the results in FIG. 3. For application layer, using the following eleven features already leads to 99.01% detection accuracy for J48 (AND 98.88%, 99.82%, 99.76% for Naive Bayes, Logistic and SVM respectively). (1) HttpHead_server, which is the type of the http server at the redirection destination of an input URL (e.g., Apache, Microsoft IIS). (2) Whois_RegDate, which is the registration date of the website that corresponds to the redirection destination of an input URL. (3) HttpHead_cacheControl, which indicates the cache management method in the server side. (4) Whois_StateProv, which is the registration state or geographical location of the website. (5) Charset, which is encoding charset of current URL (e.g., iso-8859-1), and hints the language a website used and its target users user population. (6) Within_Domain, which indicates whether the destination URL and the original URL are in the same domain. (7) Updated_date, which indicates the last update date of the final redirection destination URL. (8) Content_type, which is an Internet media type of the final redirection destination URL (e.g., text/html, text/javascript). (9) Number of Redirect, which is the total number of redirects embedded into an input URL to destination URL. Malicious web pages often have a larger number of redirects than benign webpages. (10) State_prov, which is the state or province of the register. It turns out that malicious webpages are mainly registered in certain areas. (11) Protocol, which indicates the transfer protocol a webpage uses. Https are normally used by benign web pages. When these 11 features are used for training classifiers, we can achieve detection accuracy of 98.22%, 97.03%, 96.69% and 99.01% for Naive Bayes, Logistic, SVM and J48 classifiers respectively.

For network-layer, using the following nine features can have good detection accuracy and lower false-negative rate. (1) avg_remote_pkt_rate, which is the average IP packets rate (packets per second) sent by the remote server. For multiple remote IP, this feature is retrieved by simple average aggregation on IP packets send rate of each single remote IP. (2) dist_remote_tcp_port, which is the number of distinct TCP ports opened by remote servers. (3) dist_remote_ip, which is the number of distinct remote server IP. (4) dns_answer_times, which is the number of DNS answers sent by DNS server. (5) flow_num, which is the number of flows. (6) avg_local_pkt_rate, which is the average IP packets send rate (packets per second) by local host. (7) dns_query_times, which is the number of DNS queries sent by local host. (8) duration, which is the duration of time consumed for a conversation between the local host and the remote server. (9) src_ip_packets, which is the number of IP packets sent by the local host to the remote server. When these nine features are used for training classifiers, we can achieve detection accuracy of 98.88%, 99.82%, 99.76% and 99.91% for Naive Bayes, Logistic, SVM and J48 classifiers respectively. An explanation of this phenomenon is the following: Because of redirection, visiting malicious URLs will cause local host to send multiple DNS queries and connect to multiple remote servers, and high volume communication because of the transferring of the malware programs.

We observe, as expected, that J48 classifier performs at least as good as the others in terms of network-layer detection and cross-layer detection. Note that in this case we have to compare the false-negative rate and false-positive rate with respect to specific number of features that are used for learning classifiers. On the other hand, it is interesting that the detection accuracy of Naive Bayes classifier can actually drop when it is learned from more features. A theoretical treatment of this phenomenon is left to future work. In Table II, we summarize the false negative/positive rates of the classifiers learned from a few features. The five application layer features and four network-layer features used in the data-level aggregation case are the top five (out of the eleven) GainRatioAttributeEval-selected features used by the application-layer classifier and the top four (out of the nine selected) GainRatioAttributeEval-selected features

TABLE II
EFFECT WHEN A FEW FEATURES ARE USED FOR LEARNING CLASSIFIERS

| | number of | Naive Bayes | | | Logistic | | | SVM | | | J48 | | |
|---|---|---|---|---|---|---|---|---|---|---|---|---|---|
| | features | Acc. | FN | FP | Acc. | FN | FP | Acc. | FN | FP | Acc. | FN | FP |
| Application | 11 | 98.22 | 7.430 | 0.95 | 97.04 | 7.430 | 2.3 | 96.69 | 7.430 | 2.7 | 98.21 | 7.430 | 0.96 |
| Network | 9 | 98.79 | 1.908 | 1.099 | 99.81 | 1.226 | 0.03 | 99.75 | 1.908 | 0.0 | 99.90 | 0.545 | 0.03 |
| Cross (data- | 5 + 4 | 98.88 | 1.908 | 1.0 | 99.81 | 1.295 | 0.02 | 99.75 | 1.908 | 0.0 | 99.91 | 0.477 | 0.03 |
| level agg.) | | | | | | | | | | | | | |
| Cross (OR- | 11 + 9 | 98.06 | 1.23 | 2.05 | 97.82 | 1.23 | 2.32 | 97.40 | 1.91 | 2.70 | 99.07 | 0.55 | 0.99 |
| aggregation) | | | | | | | | | | | | | |
| Cross-layer | 11 + 9 | 98.96 | 8.11 | 0.000 | 99.04 | 7.43 | 0.010 | 99.05 | 7.43 | 0.000 | 99.05 | 7.43 | 0.00 |
| (AND- | | | | | | | | | | | | | |
| aggregation) | | | | | | | | | | | | | |

(ACC.: DETECTION ACCURACY;
FN: FALSE -NEGATIVE RATE;
FP: FALSE-POSITIVE RATE;
a + b: a APPLICATION-LAYER FEATURES AND b NETWORK-LAYER FEATURES).

used by network-layer classifier, respectively. The eleven application-layer features and nine network-layer features used in the OR-aggregation and AND-aggregation are the same as the features that are used in the application layer and network-layer classifiers.

We make the following observations. First, J48 classifier learned from fewer application-layer features, network-layer features and cross-layer features can still maintain very close detection accuracy and false negative rate.

Second, for all data-level aggregation cross layer classifiers, five application-layer features (i.e., HttpHead_server, Whois_RegDate, HttpHead_cacheControl, Within_Domain, Updated_date) and four network-layer features (i.e., avg_remote_pkt_rate, dist_remote_tcp_port, dist_remote_ip, dns_answer_times) can already achieve almost as good as, if not better than, the other scenarios. In particular, J48 actually achieves 99.91% detection accuracy, 0.477% false-negative rate, and 0.03% false-positive rate, which is comparable to the J48 classifier learned from all the 124 features, which leads to 99.91% detection accuracy, 0.47% false-negative rate, and 0.03% false-positive rate without using any feature selection method (see Table I). This means that data-level aggregation with as few as nine features is practical and highly accurate.

Third, there is an interesting phenomenon about Naïve Bayes classifier: the detection accuracy actually will drop when more features are used for building classifiers. We leave it to future work to theoretically explain the cause of this phenomenon.

Our cross-layer system can be used as front-end detection tool in practice. As discussed above, we aim to make our system as fast and scalable as the static analysis approach while achieving high detection accuracy, low false-negative rate, and low false-positive rate as the dynamic approach. In the above, we have demonstrated that our cross-layer system, which can be based on either the data-level aggregation or the OR-aggregation and even using as few as nine features in the case of data-level aggregation, achieved high detection accuracy, low false-negative rate, and low false-positive rate. In what follows we confirm that, even without using any type of optimization and collecting all the 124 features rather than the necessary nine features, our system is at least about 25 times faster than the dynamic approach. To be fair, we should note that we did not consider the time spent for learning classifiers and the time spent for applying a classifier to the data collected from a given URL. This is because the learning process is conducted once for a while (e.g., a day) and only requires 2.69 seconds for J48 to process network layer data on a common computer, and the process of applying a classifier to a given data only incurs less than 1 second for J48 to process network layer data on a common computer.

In order to measure the performance of our data collection system, it would be natural to use the time spent on collecting the cross-layer data information and the time spent by the client honeypot system. Unfortunately, this is not feasibly because our data collection system is composed of several computers with different hardware configurations. To resolve this issue, we conducted extra experiments using two computers with the same configuration. One computer will run our data collection system and the other computer will run client honeypot system. The hardware of the two computers is Intel Xeon X3320 4 cores CPU and 8 GB memory. We use Capture-HPC client honeypot version 3.0.0 and VMware Server version 1.0.6, which runs on top of a Host OS (Windows Server 2008) and supports 5 Guest OS (Windows XP sp3). Since Capture-HPC is high-interactive and thus necessarily heavy-weight, we ran five guest OS (according to our experiment, more guest OS will make the system unstable), used default configuration of Capture-HPC. Our data collection system uses a crawler, which was written in JAVA 1.6 and runs on top of Debian 6.0. Besides the JAVA based crawler, we also use IPTABLES and modified version of TCPDUMP to obtain high parallel capability. When running multiple crawler instances at the same time, the application features can be obtained by each crawler instance, but the network feature of each URL should also be extracted. TCPDUMP software can be used to capture all the outgoing and incoming network traffic on local host. IPTABLES can be configured to log network flow information with respect to processes with different user identification. We use different user identifications to run each crawler instance, extract network flow information for each URL and use the flow attributes to extract all the network packets of a URL. Because our Web Crawler is light-weight, we conservatively ran 50 instances in our experiments.

TABLE III
TIME COMPARISON BETWEEN
CAPTURE-HPC AND OUR CRAWLER

| Input URLs | Our crawler | Capture-HPC |
|---|---|---|
| Malicious (1,562) | 4 min | 98 min |
| Benign (1,500) | 4 min | 101 min |

The input URLs in our performance experiments consist of 1,562 malicious URLs that are accessible, and 1,500 benign URLs that are the listed on the top of the top 10,000 Alexa URL lists. Table III shows the performance of the two systems. We observe that our crawler is about 25 times faster than Capture-HPC, which demonstrates the performance gain of our system. We note that in the experiments, our cross-layer data collection system actually collected all 124 features. The performance can be further improved if only the necessary smaller number of features (nine in the above data-level aggregation method) is collected.

### SUMMARY

We demonstrated that cross-layer detection will lead to better classifiers. We further demonstrated that using as few as nine cross-layer features, including five application-layer features and four network-layer features, the resulting J48 classifier is almost as good as the one that is learned using all the 124 features. We showed that our data system can be at least about 25 times faster than the dynamic approach based on Capture-HPC.

### III. Resilience Analysis Against Adaptive Attacks

Cyber attackers often adjust their attacks to evade the defense. In previous section, we demonstrated that J48 classifier is a very powerful detection tool, no matter all or some features are used for learning them. However, it may be possible that the J48 classifier can be easily evaded by an adaptive attacker. In this section, we partially resolve the issue.

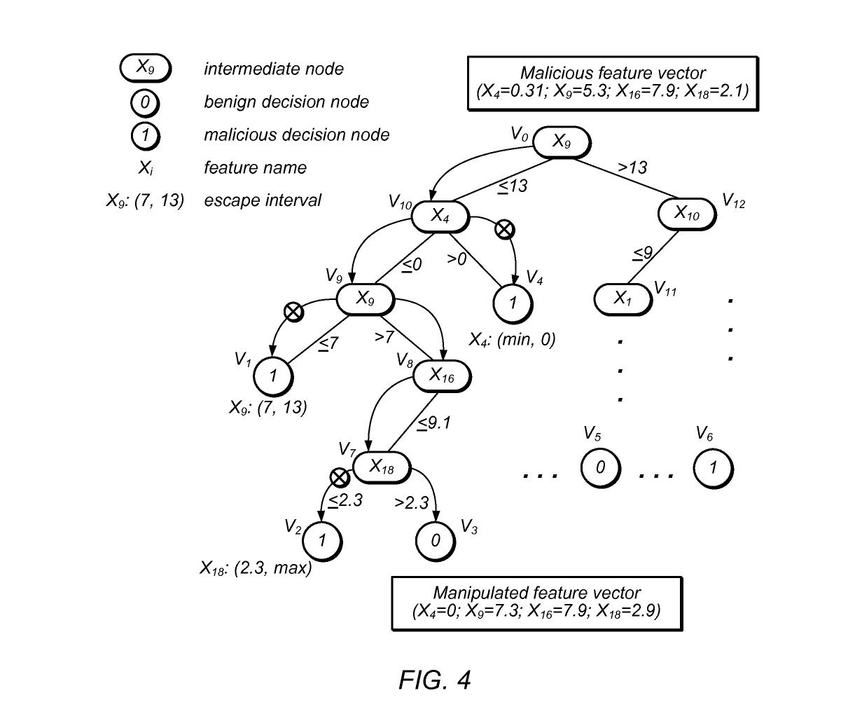

Because the problem is fairly complicated, we start with the example demonstrated in FIG. 4. Suppose that the attacker knows the defender's J48 classifier M. The leaves are decision nodes with class 0 indicating benign URL, which is called benign decision node, and 1 indicating malicious URL, which is called malicious decision node. Given the classifier, it is straightforward to see that a URL associated with feature vector M=(X₄=0.31; X₉=5.3; X₁₆=7.9; X₁₈=2.1), is malicious because of the decision path:

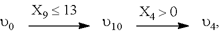

To evade detection, an adaptive attacker can adjust the URL properties that lead to feature vector (X₄=0; X₉=7.3; X₁₆=7.9; X₁₈=2.9). As a consequence, the URL will be classified as benign because of the decision path:

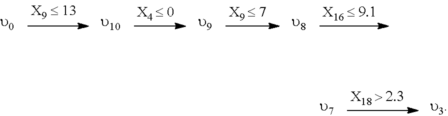

Now the question is: how the attacker may adjust to manipulate the feature vectors? How should the defender respond to adaptive attacks? As a first step towards a systematic study, in what follows we will focus on a class of adaptive attacks and countermeasures, which are characterized by three adaptation strategies that are elaborated below.

### A. Resilience Analysis Methodology

### Three Adaptation Strategies

Suppose that system time is divided into epochs 0, 1, 2, . . . . The time resolution of epochs (e.g., hourly, weekly, or monthly) is an orthogonal issue and its full-fledged investigation is left for future work. At the ith epoch, the defender may use the collected data to learn classifiers, which are then used to detect attacks at the jth epoch, where j>i (because the classifier learned from the data collected at the current epoch can only be used to detect future attacks at any appropriate time resolution). Suppose that the attacker knows the data collected by the defender and also knows the learning algorithms used by the defender, the attacker can build the same classifiers as the ones the defender may have learned. Given that the attacker always acts one epoch ahead of the defender, the attacker always has an edge in evading the defender's detection. How can we characterize this phenomenon, and how can we defend against adaptive attacks?

In order to answer the above question, it is sufficient to consider epoch i. Let D₀ be the cross-layer data the defender has collected. Let M₀ be the classifier the defender learned from the training portion of D₀. Because the attacker knows essentially the same M₀, the attacker may correspondingly adapt its activities in the next epoch, during which the defender will collect data D₁. When the defender applies M₀ to D₁ in real-time, the defender may not be able to detect some attacks whose behaviors are intentionally modified by the attackers to bypass classifier M₀. Given that the defender knows that the attacker may manipulate its behavior in the (i+1)st epoch, how would the defender respond? Clearly, the evasion and counter evasion can escalate further and further. While it seems like a perfect application of Game Theory to formulate a theoretical framework, we leave its full-fledged formal study future work because there are some technical subtleties. For example, it is infeasible or even impossible to enumerate all the possible manipulations the attacker may mount against M₀. As a starting point, we here consider the following three strategies that we believe to be representative.

### Parallel Adaptation

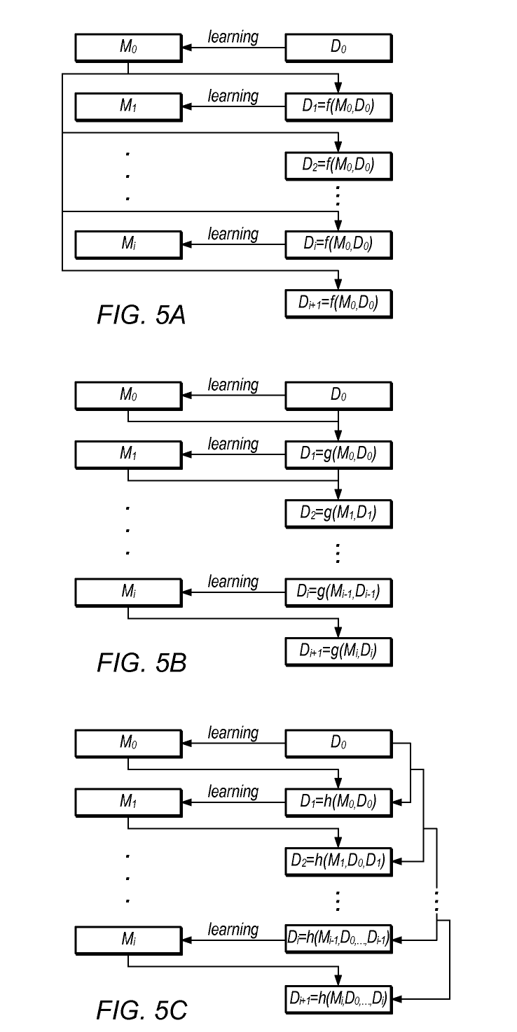

This strategy is highlighted in FIG. 5A. Specifically, given D₀ (the data the defender collected) and M₀ (the classifier the defender learned from D₀), the attacker adjusts its behavior accordingly so that D₁=ƒ(D₀,M₀), where ƒ is some appropriately-defined randomized function that is chosen by the attacker from some function family. Knowing what machine learning algorithm the defender may use, the attacker can learn M₁ from D₁ using the same learning algorithm. Because the attacker may think that the defender may know about ƒ, the attacker can repeatedly use ƒ multiple times to produce Dᵢ=ƒ(M₀,D₀) and then learn Mᵢ from Dᵢ, where i=2, 3, . . . . Note that because ƒ is randomized, it is unlikely that Dᵢ=Dⱼ for i≠j.

### Sequential Adaptation

This strategy is highlighted in FIG. 5(b). Specifically, given D₀ (the data the defender collected) and M₀ (the classifier the defender learned from D₀), the attacker adjusts its behavior so that D₁=g(D₀,M₀), where g is some appropriately defined randomized function that is chosen by the attacker from some function family, which may be different from the family of functions from which ƒ is chosen. Knowing what machine learning algorithm the defender may use, the attacker can learn M₁ from D₁ using the same learning algorithm. Because the attacker may think that the defender may know about g, the attacker can repeatedly use g multiple times to produce Dᵢ=g(Mᵢ−1,D₁−1) and then learn Mᵢ from Dᵢ, where i=1, 2, . . . .

### Full Adaptation

This strategy is highlighted in FIG. 5(c). Specifically, given D₀ and M₀, the attacker adjusts its behavior so that D₁=h(D₀,M₀) for some appropriately-defined randomized function that is chosen by the attacker from some function family, which may be different from the families of functions from which f and g are chosen. Knowing what machine learning algorithm the defender may use, the attacker can learn M₁ from D₁ using the same learning algorithm. Because the attacker may think that the defender may know about h, the attacker can repeatedly use h multiple times to produce Dᵢ=h(Mᵢ−1, D₀, . . . , Dᵢ−1) and then learn Mᵢ from Dᵢ, where i=1, 2, . . . .

Defender's Strategies to Cope with the Adaptive Attacks

How should the defender react to the adaptive attacks? In order to characterize the resilience of the classifiers against adaptive attacks, we need to have real data, which is impossible without participating in a real attack-defense escalation situation. This forces us to use some method to obtain synthetic data. Specifically, we design functions ƒ, g, and h to manipulate the data records corresponding to the malicious URLs, while keeping intact the data records corresponding to the benign URLs. Because ƒ, g, and h are naturally specific to the defender's learning algorithms, we here propose the following specific functions/algorithms corresponding to J48, which was shown in the previous section to be most effective for the defender.

At a high-level, Algorithm 1 takes as input dataset D₀ and adaptation strategy STε{ƒ, g, h}. In our case study, the number of adaptation iterations is arbitrarily chosen as 8. This means that there are 9 classifiers M₀, M₁, . . . , M_{S}, where Mᵢ is learned from Dᵢ.

For parallel adaptation, we consider the following ƒ function: Dᵢ consists of feature vectors in D₀ that correspond to benign URLs, and the manipulated versions of the feature vectors in D₀ that correspond to the malicious URLs.

For sequential adaptation, we consider the following g function: Dᵢ+1 consist of the benign portion of D₀, and the manipulated portion of Dᵢ where the manipulation is conducted with respect to classifier Mᵢ.

For full adaptation, we consider the following h function: the benign portion of Dᵢ+1 is the same as the benign portion of D₀, and the manipulated portion is derived from D₀, D₁, . . . , Dᵢ and D′ᵢ, where D′ᵢ is obtained by manipulating Dᵢ with respect to classifier Mᵢ.

Algorithm 1 Defender's algorithm main(D₀, ST)

INPUT: D₀ is original feature vectors of all URLs, ST
indicates the attack strategy
OUTPUT: M₀, M₁, . . . , M₈, which are the classifiers the
defender learned

| | |
|---|---|
| 1: | initialize array D₀, D₁, . . . , D₉ where Dᵢ is a list |
| | of feature vectors conesponding to benign URLs |
| | (dubbed benignFeatureVector) and to malicious |
| | URLs (dubbed maliciousFeatureVector). |
| 2: | initialize Mᵢ(i = 0, . . . , 8) where Mᵢ is a J48 classifier |
| | corresponding to Dᵢ. |
| 3: | for i = 0 to 8 {8 is the number of adaptation iterations} |
| | do |
| 4: | Mᵢ ← J48.buildmodel(Dᵢ) |
| 5: | switch |
| 6: | case 1 ST = PARALLEL-ADAPTATION |
| 7: | Dᵢ ← Dᵢ.benignFeatureVector + |
| | manipulate (D₀.maliciousFeatureVector, M₀) |
| | {this is one example of function f} |
| 8: | case 2 ST = SEQUENTIAL-ADAPTATION |
| 9: | Dᵢ₊₁ ← Dᵢ.benignFeatureVector + |
| | manipulate (Dᵢ.maliciousFeatureVector, Mᵢ) |
| | {this is one example of function g} |
| 10: | case 3 ST = FULL-ADAPTATION |
| 11: | Dᵢ₊₁.benignFeatureVector ← |
| | D₀.benignFeatureVector |
| 12: | Dᵢ′ ← |
| | manipulate (Di.maliciousFeatureVector, Mᵢ) |
| 13: | Dᵢ₊₁.maliciousFeatureVector ← |
| 14: | for j = 1 to MaxFeatureIndex |
| 15: | randomly choose d from |
| | Dₖ.maliciousFeatureVector [j](k = 0, .., i) |
| | and Dᵢ′[j] |
| 16: | D_{i +1}.maliciousFeatureVector[j] ← d |
| 17: | end for |
| 15: | end switch |
| 19: | end for |
| 20: | return Mᵢ(i = 0, . . . , 8) |

Algoritim 2 Algorithm preparation(DT)

INPUT: decision tree DT
OUTPUT: a manipulated decision
tree

| | |
|---|---|
| 1: | initiate an empty queue Q |
| 2: | for all v ε DT do |
| 3: | if v is leaf AND v = “malicious” then |
| 4: | append v to queue Q |
| 5: | end if |
| 6: | end for |
| 7: | for all v ε Q do |
| 8: | v.featureName ← v.parent.featureName |
| 9: | v.interval ← Domain(v.parent) \ |
| | v.escape_interval {Domain(X) is the domain of |
| | feature X} |
| 10: | v′ ← v.parent |
| 11: | while v′ ≠ root do |
| 12: | if v′.featureName = v.feautreName then |
| 13: | v.escape_interval ← |
| | v′.interval∩v.escape_interval |
| 14: | end if |
| 15: | v′ ← v′.parent |
| 16: | end while |
| 17: | end for |
| 18: | return DT |

Algoritim 3 Algorithm manipulate(D, M) for transform-
inf malicious feature vector to benign feature vector

INPUT: D is dataset, M is classifier
OUTPUT: manipulated dataset

| | |
|---|---|
| 1: | DT ← M.DT { DT is the J48 decision tree} |
| 2: | preparation(DT) |
| 3: | for all feature vector f v ε D do |
| 4: | v ← DT.root |
| 5: | v ← 0 { t is the manipulated time to fv} |
| 6: | while NOT (v is leaf AND v ≠ “benign”) AND t ≦ |
| | MAX_ALLOWED_TIME do |
| 7: | if v is leaf AND v = “malicious” then |
| 8: | t ← t + 1 |
| 9: | pick a value n ε v.intrval at random |
| 10: | fv.setFeatureValue(v.featureName, n) |
| 11: | v ← v.sibling |
| 12: | end if |
| 13: | if v is not leaf then |
| 14: | if fv.featureValue ≦ v.featureValue then |
| 15: | v ← v.leftChild |
| 16: | else |
| 17: | v ← v.rightChild |
| 18: | end if |
| 19: | end if |
| 20: | end while |
| 21: | end for |
| 22: | return D |

In order to help understand Algorithm 2, let us consider another example in FIG. 4. Feature vector (X₄=−1; X₉=5; X₁₆=5; X₁₈=0) will lead to decision path:

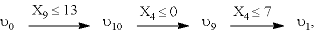

which means that the corresponding URL is classified as malicious. For feature X₉, let us denote its domain by Domain(X₉)={min₉, . . . , max₉}, where min₉ (max₉) is the minimum (maximum) value of X₉. In order to evade detection, the attacker can manipulate the value of feature X₉ so that ν₁ will not be on the decision path. This can be achieved by assigning a random value from interval (7, 13], which is called escape interval and can be derived as

$$( [ {min}_{9} , {max}_{9} ] - [ {min}_{9} , 7 ] ) ⋂ ( 13 , {max}_{9} ] = ( Domain ( {X}_{9} ) \backslash {v}_{9} \cdot interval ) ⋂ {v}_{0} \cdot interval .$$

Algorithm 2 is based on the above observation and aims to assign escape interval to each malicious decision node which is then used in Algorithm 3.

The basic idea underlying Algorithm 3 is to transform a feature vector, which corresponds to a malicious URL, to a feature vector that will be classified as benign. We use the same example to illustrate how the algorithm works. Let us against consider feature vector (X₄=−1; X₉=5; X₁₆=5; X₁₈=5), the adaptive attacker can randomly choose a value, say 8, from ν1.escape interval and assign it to X₉. This will make the new decision path avoid vi but go through its sibling ν8 because the new decision path becomes

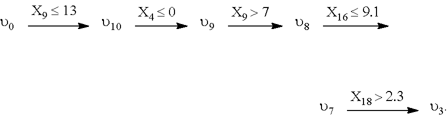

The key idea is the following: if the new decision path still reaches a malicious decision node, the algorithm will recursively manipulate the values of features on the path by diverting to its sibling node.

### Evaluation Method

Because there are three aggregation methods and both the attacker and the defender can take the three adaptation strategies, there are 3×3×3=27 scenarios. In the current version of the paper, for each aggregation method, we focus on three scenarios that can be characterized by the assumption that the attacker and the defender will use the same adaptation strategy; we will extend to cover all possible scenarios to future study. In order to characterize the resilience of cross-layer detection against adaptive attacks, we need some metrics. For this purpose, we compare the effect of non-adaptive defense and adaptive defense against adaptive attacks. The effect will be mainly illustrated through the true-positive rate, which intuitively reflects the degree that adaptive attacks cannot evade the defense. The effect will also be secondarily illustrated through the detection accuracy, false-negative rate and false-positive rate, which more comprehensively reflect the overall quality of the defense. For each scenario, we will particularly consider the following three configurations:

1. The attacker does not adapt but the defender adapts multiple times.
2. The attacker adapts once but the defender adapts multiple times.
3. Both the attacker and the defender adapt multiple times.

### B. Cross-Layer Resilience Analysis

### Resilience Measurement Through True-Positive Rate

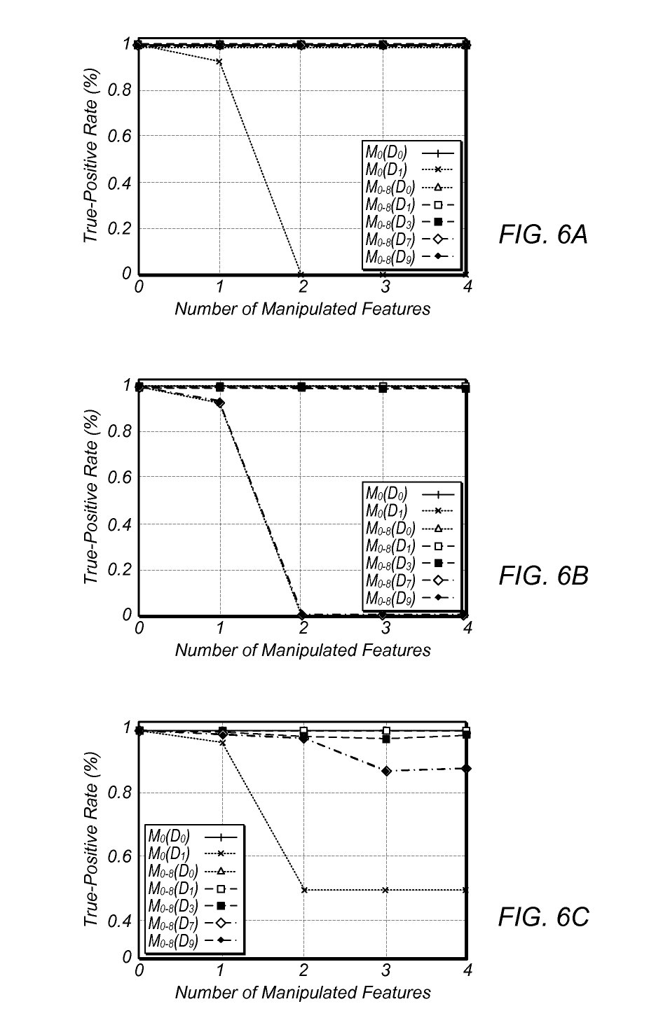

FIG. 6 plots the results in the case of data-level aggregation. We observe that if the attacker is adaptive but the defender is non-adaptive, then most malicious URLs will not be detected as we elaborate below. For parallel and sequential adaptations, the true-positive rate of M₀(D₁) drops to 0% when the attacker adapts its behavior by manipulating two features. Even in the case of full adaptation defense, the true-positive rate of M₀(D₁) can drop to about 50% when the attacker adapts its behavior by manipulating two features. We also observe that if the attacker is not adaptive but the defender is adaptive, then most malicious URLs will be detected. This is shown by the curves corresponding to M₀₋₄(D₀) and M₀₋₈(D₀). We further observe that if both attacker and defender are adaptive, then most malicious URLs will still be detected. This is observed from the curves corresponding to M₀₋₄(D₁) and M₀₋₈(D₁).

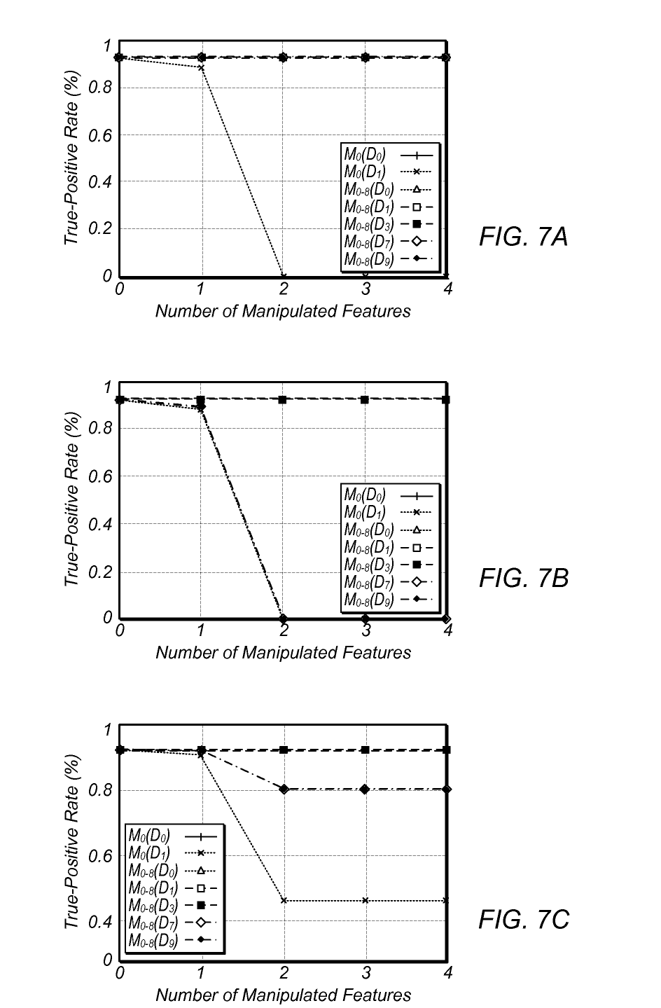

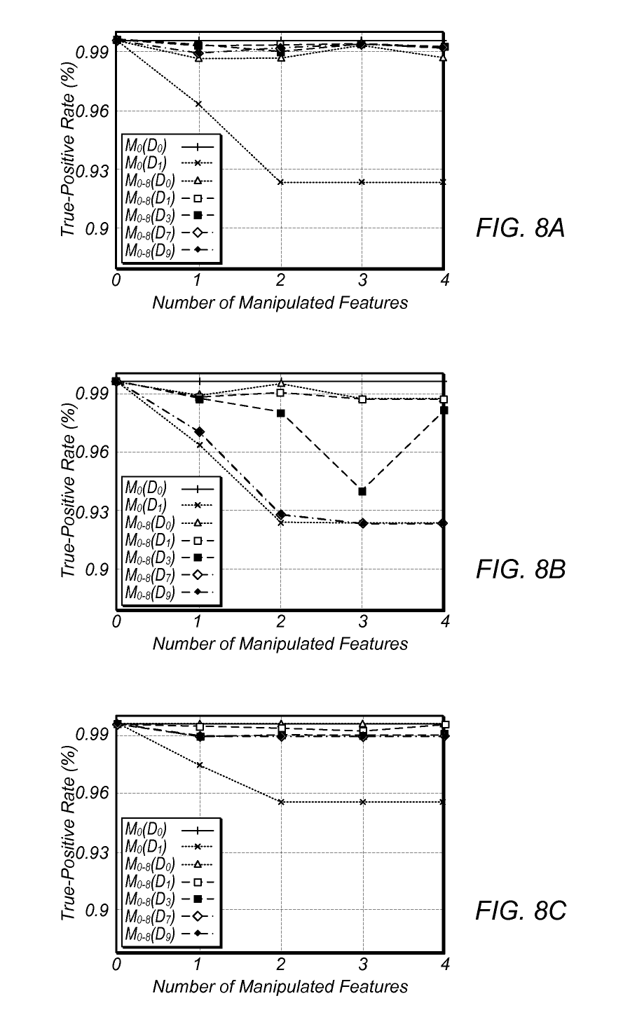

FIG. 7 plots the simulation results in the case of AND-aggregation aggregation, which is similar to the results in the case of data-level aggregation. For example, if the attacker is adaptive but the defender is non-adaptive, most malicious URLs will not be detected because the true-positive rate of M₀(D₁) becomes 0% when the attacker manipulates two features in the cases of parallel and sequential adaptations. FIG. 8 plots the results in the case of OR-aggregation cross-layer detection. We observe that if the attacker is adaptive but the defender is non-adaptive, around additional 2-4% malicious URLs will not be detected. This can be seen from the fact that the true-positive rate of M₀(D₁) drops when the attacker adapts its behavior by manipulating two features. We observe that if the attacker is not adaptive but the defender is adaptive, then most malicious URLs will be detected as long as the defender adapts 4 times (i.e., the final decision will be based on the voting results of five models M₀, . . . , M₄). This is shown by the true-positive rate curves corresponding to M₀₋₄(D₀) and M₀₋₈(D₀), respectively. We also observe that if both attacker and defender are adaptive, then the true-positive rate will be as high as the non-adaptive case. This is observed from the curves corresponding to M₀₋₄(D₁) and M₀₋₈(D₁). Finally, we observe, by comparing FIGS. 6-8, that data-level and AND-aggregation are more vulnerable to adaptive attacks if the defender does not launch adaptive defense.

### Resilience Measurement Through Detection Accuracy, False-Negative Rate, and False-Positive Rate

In the above we highlighted the effect of (non-)adaptive defense against adaptive attack. Table IV describes the detection accuracy, false-negative rate, and false-positive rate of adaptive attacks against adaptive attacks in the case of parallel adaptation. Note that for sequential and full adaptations we have similar results, which are not presented for the sake of conciseness.

### Are the Features Whose Manipulation LED to Evasion Those Most Important Ones?

Intuitively, one would expect that the features, which are important to learn the classifiers, would also be the features that attacker would manipulate for evading the defense. It is somewhat surprising to note that it is not necessarily the case. In order to gain some insight into the effect of manipulation, we consider application-layer, network-layer, and cross-layer defenses.

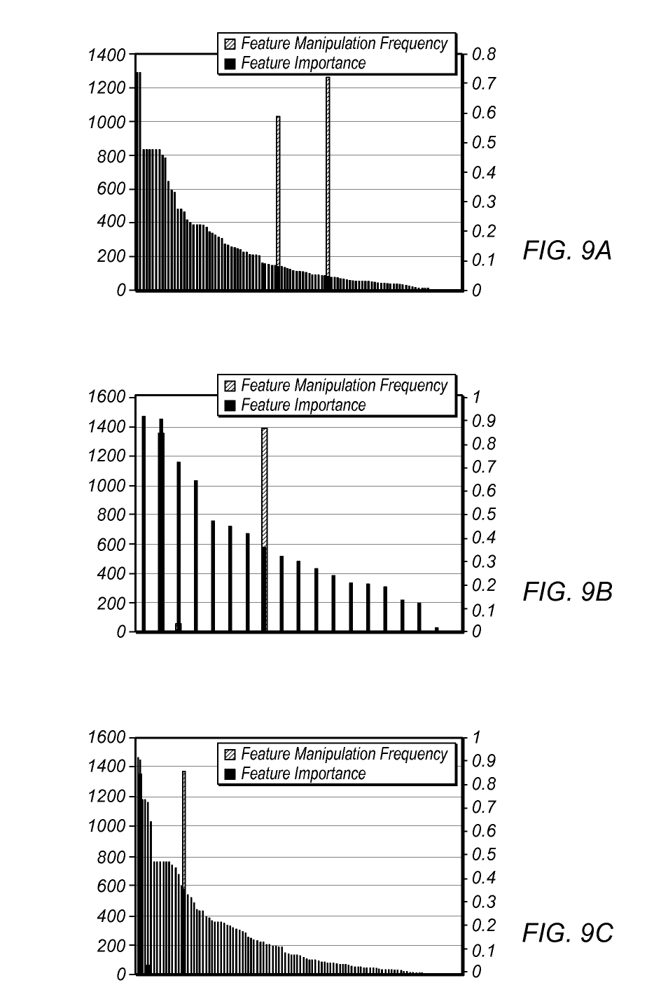

FIG. 9 shows which features are manipulated by the attacker so as to bypass classifier M0. In order to evade the 1,467 malicious URLs from the defense, our algorithm manipulated a few features. We observe that there is no simple correspondence between the most often manipulated features and the most important features, which were ranked using the GainRatioAttributeEval feature selection method mentioned in Section II-C.

At the application-layer, there are only two features, namely Postal Code of the register website and number of redirection that need be manipulated in order to evade the detection of application-layer M₀. These two features are not very important in terms of their contributions to the classifiers, but their manipulation allows the attacker to evade detection. This phenomenon tells us that non-important features can also play an important role in evading detection. The reason that only two features need be manipulated can be attributed to that the application-layer decision tree is unbalanced and has short paths.

TABLE IV
ADAPTIVE DEFENSE VS. (NON-)ADAPTIVE ATTACK USING CROSS -LAYER DETECTION
(TP: TRUE-POSITIVE RATE: FN: FALSE-NEGATIVE RATE: FP: FALSE-POSITIVE RATE).
NOTE THAT TP +FN = 1.

| | | M₀(D₀) | | | M₀₋₈(D₀) | | | M₀(D₁) | | | M₀₋₈(D₁) | | |
|---|---|---|---|---|---|---|---|---|---|---|---|---|---|
| Strategy | Layer | TP | FN | FP | TP | FN | FP | TP | FN | FP | TP | FN | FP |
| Parallel | Cross-layer (data-level agg.) | 99.5 | 0.5 | 0.0 | 98.7 | 1.3 | 0.0 | 0.0 | 1.0 | 0.0 | 99.3 | 0.7 | 0.0 |
| | Cross-layer (OR-aggregation) | 99.5 | 0.5 | 0.1 | 98.7 | 1.3 | 0.0 | 92.4 | 7.6 | 0.1 | 99.2 | 0.8 | 0.0 |
| | Cross-layer (AND-aggregation) | 92.4 | 7.6 | 0.0 | 92.4 | 7.6 | 0.0 | 0.0 | 1.0 | 0.0 | 92.4 | 7.6 | 0.0 |
| Sequential | Cross-layer (data-level agg.) | 99.5 | 0.5 | 0.0 | 98.8 | 1.2 | 0.0 | 0.0 | 1.0 | 0.0 | 98.7 | 1.3 | 0.0 |
| | Cross-layer (OR-aggregation) | 99.5 | 0.5 | 0.1 | 98.8 | 1.2 | 0.0 | 92.4 | 7.6 | 0.1 | 98.7 | 1.3 | 0.0 |
| | Cross-layer (AND-aggregation) | 92.4 | 7.6 | 0.0 | 92.4 | 7.6 | 0.0 | 0.0 | 1.0 | 0.0 | 92.4 | 7.6 | 0.0 |
| Full | Cross-layer (data-level agg.) | 99.5 | 0.5 | 0.0 | 99.5 | 0.5 | 0.0 | 49.6 | 50.4 | 0.0 | 99.2 | 0.8 | 0.0 |
| | Cross-layer (OR-aggregation) | 99.5 | 0.5 | 0.1 | 99.5 | 0.5 | 0.0 | 95.6 | 4.4 | 0.1 | 99.5 | 0.5 | 0.0 |
| | Cross-layer (AND-aggregation) | 92.4 | 7.6 | 0.0 | 92.4 | 7.6 | 0.0 | 46.4 | 53.6 | 0.0 | 92.4 | 7.6 | 0.0 |

At the network-layer, there are four features that are manipulated in order to evade the detection of network-layer M₀. The four features that are manipulated are: Distinct remote IP, duration (from 1st packets to last packets), application packets from local to remote, distinct number of TCP ports targeted (remote server). From FIG. 9, we see that two of them are not the most important features in terms of their contributions to the classifiers. However, they are most often manipulated because they correspond to nodes that are typically close to the leaves that indicate malicious URLs. Another two features are important features. From the observation of decision tree, there is a benign decision node with height of 1. This short benign path make the malicious URLs easily evade by only manipulate 1 feature.

At the cross-layer, there are only four features that need be manipulated in order to evade the detection of cross-layer M₀ as shown in Table IV. Like the network-layer defense, the manipulation of four features will lead to the high evasion success rate. The four features are: Distinct remote IP, duration (from 1st packets to last packets), application packets from local to remote, distinct number of TCP ports targeted (remote server), which are same to manipulated features of network layer. Two of the four features are also important features in terms of their contributions to the classifiers. Some of the four features correspond to nodes that are close to the root, while the others correspond to nodes that are close to the leaves.

The above phenomenon, namely that some features are manipulated much more frequently than others, are mainly caused by the following. Looking into the structure of the decision trees, we find that the often-manipulated features correspond to the nodes that are close to the leaves (i.e., decision nodes). This can also explain the discrepancy between the feature importance in terms of their contribution to the construction of the classifiers (red bars in FIG. 9) and the feature importance in terms of their contribution to the evasion of the classifiers (blue bars in FIG. 9). Specifically, the important features for constructing classifiers likely correspond to the nodes that are the root or closer to the root, and the less important features are closer to the leaves. Our bottom-up (i.e., leaf-to-root) search algorithm for launching adaptive attacks will always give preferences to the features that are closer to the leaves. Nevertheless, it is interesting to note that a feature can appear on a node close to the root and on another node close to a leaf, which implies that such a feature will be important and selected for manipulation.

From the defender's perspective, OR-aggregation cross-layer detection is better than data-level aggregation and AND-aggregation cross-layer detection, and full adaptation is better than parallel and sequential adaptations in the investigated scenarios. Perhaps more importantly, we observe that from the defender's perspective, less important features are also crucial to correct classification. If one wants to build a classifier that is harder to bypass/evade (i.e., the attacker has to manipulate more features), we offer the following principles guidelines.

A decision tree is more resilient against adaptive attacks if it is balanced and tall. This is because a short path will make it easier for the attacker to evade by adapting/manipulating few features. While a small number of features can lead to good detection accuracy, it is not good for defending adaptive attackers. From the Table V, only 3 features in network-layer data, 1 feature in application-layer data and 2 in data-aggregation cross-layer are manipulated with fewer features.

TABLE V
# OF MANIPULATED FEATURES W/OR W/O FEATURE
SELECTION (a/b: THE INPUT J48 CLASSIFIER WAS
LEARNED FROM DATASET OF a FEATURES, OF
WHICH b FEATURES ARE MANIPULATED FOR EVASION).

| | app-layer | net-layer | data-level agg. |
|---|---|---|---|
| w/o feature selection | 109/2 | 19/4 | 128/4 |
| w/feature selection | 9/1 | 11/3 | 9/2 |

Both industry and academia are actively seeking effective solutions to the problem of malicious websites. Industry has mainly offered their proprietary blacklists of malicious websites, such as Google's Safe Browsing. Researchers have used Logistic regression to study phishing URLs, but without considering the issue of redirection. Redirection has been used as indicator of web spams.

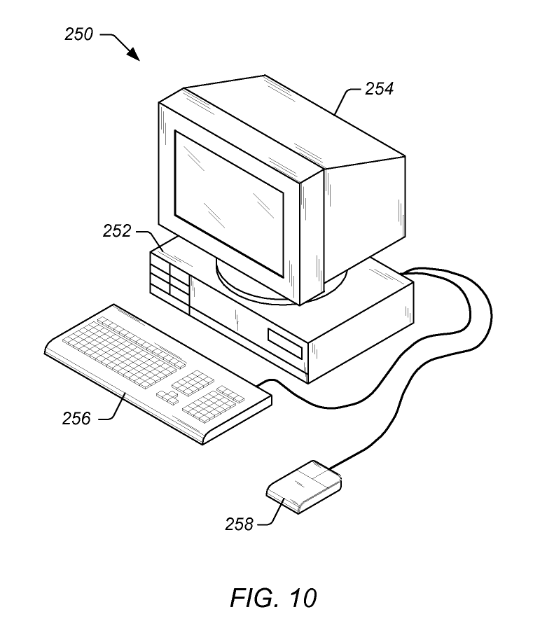

FIG. 10 illustrates an embodiment of computer system 250 that may be suitable for implementing various embodiments of a system and method for detecting malicious websites. Each computer system 250 typically includes components such as CPU 252 with an associated memory medium such as disks 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for detecting malicious websites.

Computer system 250 may include a memory medium on which computer programs according to various embodiments may be stored. The term “memory medium” is intended to include an installation medium, e.g., a CD-ROM, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement a method for detecting malicious websites. The software program(s) may be implemented in various ways, including, but not limited to, procedure-based techniques, component-based techniques, and/or object-oriented techniques, among others. For example, the software programs may be implemented using ASP.NET, JavaScript, Java, ActiveX controls, C++ objects, Microsoft Foundation Classes (“MFC”), browser-based applications (e.g., Java applets), traditional programs, or other technologies or methodologies, as desired. A CPU such as host CPU 252 executing code and data from the memory medium may include a means for creating and executing the software program or programs according to the embodiments described herein.

### Adaptive Attack Model and Algorithm

The attacker can collect the same data as what is used by the defender to train a detection scheme. The attacker knows the machine learning algorithm(s) the defender uses to learn a detection scheme (e.g., J48 classifier or decision tree), or even the defender's detection scheme. To accommodate the worst-case scenario, we assume there is a single attacker that coordinates the compromise of websites (possibly by many sub-attackers). This means that the attacker knows which websites are malicious, while the defender aims to detect them. In order to evade detection, the attacker can manipulate some features of the malicious websites. The manipulation operations can take place during the process of compromising a website, or after compromising a website but before the website is examined by the defender's detection scheme.

More precisely, a website is represented by a feature vector. We call the feature vector representing a benign website benign feature vector, and malicious feature vector otherwise. Denote by D′₀ the defender's training data, namely a set of feature vectors corresponding to a set of benign websites (D′₀.benign) and malicious websites (D′₀.malicious). The defender uses a machine learning algorithm MLA to learn a detection scheme M₀ from D′₀ (i.e., M₀ is learned from one portion of D′₀ and tested via the other portion of D′₀). As mentioned above, the attacker is given M₀ to accommodate the worst-case scenario. Denote by D₀ the set of feature vectors that are to be examined by M₀ to determine which feature vectors (i.e., the corresponding websites) are malicious. The attacker's objective is to manipulate the malicious feature vectors in D₀ into some D_{α} so that M₀(D_{α}) has a high false-negative rate, where α>0 represents the number of rounds the attacker conducts the manipulation operations.

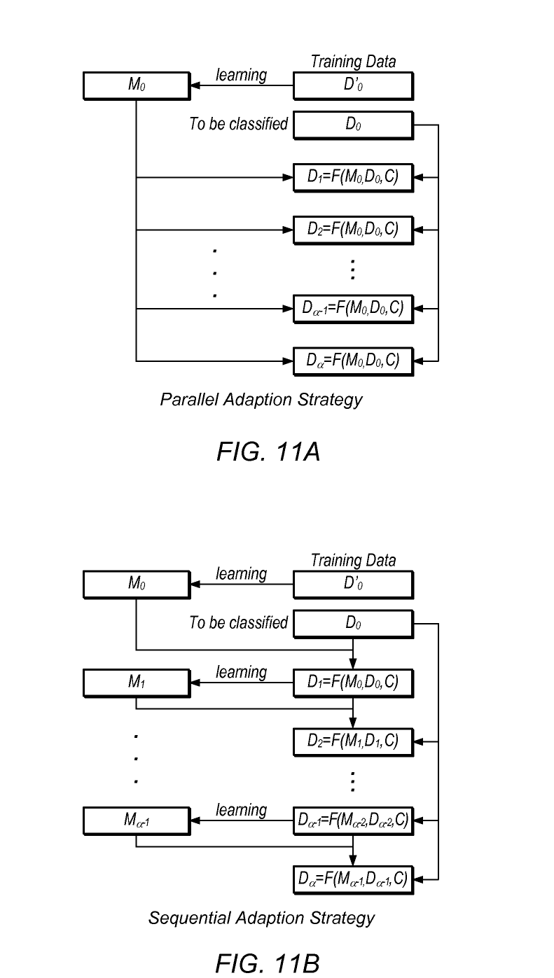

The above discussion can be generalized to the adaptive attack model highlighted in FIGS. 11A-C. The model leads to adaptive attack Algorithm 4, which may call Algorithm 5 as a sub-routine. Specifically, an adaptive attack is an algorithm is an algorithm AA(MLA, M₀, D₀, ST, C, F, α), where MLA is the defender's machine learning algorithm, D′₀ is the defender's training data, M₀ is the defender's detection scheme that is learned from D′₀ by using MLA, D₀ is the feature vectors that are examined by M₀ in the absence of adaptive attacks, ST is the attacker's adaptation strategy, C is a set of manipulation constraints, F is the attacker's (deterministic or randomized) manipulation algorithm that maintains the set of constraints C, α is the number of rounds (≧1) the attacker runs its manipulation algorithms (F). D_{α} is the manipulated version of D₀ with malicious feature vectors D₀.malicious manipulated. The attacker's objective is make M₀(D_{α}) have high false-negative rate.

Algorithm 4 Adaptive attack AA (MLA, M₀, D₀, ST, C, F, α)

INPUT: MLA is defender's machine learning algorithm, M₀ is defender's
detection scheme, D₀ = D₀.malicious ∪ D₀.benign where malicious feature
vectors (D₀.malicious) are to be manipulated (to evade detection of M₀), ST
is attacker's adaptation strategy, C is a set of manipulation constraints, F is
attacker's manipulation algorithm, α is attacker's number of adaptation rounds
OUTPUT: D_{α}

| | |
|---|---|
| 1: | initialize array D₁, . . . , D_{α} |
| 2: | for i=1 to α do |
| 3: | if ST == parallel-adaptation then |
| 4: | Dᵢ ← F(M₀, D₀, C) {manipulated version of D₀} |
| 5: | else if ST == sequential-adaptation then |
| 6: | Dᵢ ← F(Mᵢ₋₁, Dᵢ₋₁, C) {manipulated version of D₀} |
| 7: | else if ST == full -adaptation then |
| 8: | Dᵢ₋₁ ← PP(D₀, . . . , Dᵢ₋₂) {see Algorithm 2} |
| 9: | Dᵢ ← F(Mᵢ₋₁, Dᵢ₋₁, C) {manipulated version of D₀} |
| 10: | end if |
| 11: | if i < α then |
| 12: | Mᵢ ← MLA(Dᵢ) {D₁, . . . , D_{α-1}, M₁, . . . , M_{α-1} are not used |
| | when ST==parallel -adaptation} |
| 13: | end if |
| 14: | end for |
| 15: | return D_{α} |

Algorithm 5 Algorithm PP (D₀, . . . ,Dₘ₋₁)

INPUT: m sets of feature vectors D₀, . . . , Dₘ₋₁ where the zth malicious
website corresponds to D₀.malicious[z], . . . , Dₘ₋₁.malicious[z]
OUTPUT: D = PP(D₀, . . . , Dₘ₋₁)

| | |
|---|---|
| 1: | D ← |
| 2: | size ← sizeof(D₀.malicious) |
| 3: | for z =1 to size do |
| 4: | D[z] [symbol] {D₀.malicious[z], . . . , Dₘ₋₁.malicious[z]} |
| 5: | D ← D ∪ D₀.benign |
| 6: | end for |
| 7: | return D |

Three basic adaptation strategies are show in FIGS. 11A-C. FIG. 11A depicts a parallel adaptation strategy in which the attacker sets the manipulated Dᵢ=F(M₀, D₀, C), where i=1, . . . , α, and F is a randomized manipulation algorithm, meaning that Dᵢ=Dⱼ for i≠j is unlikely.
FIG. 11B depicts a sequential adaptation strategy in which the attacker sets the manipulated Dᵢ=F(Mᵢ₋₁, Dᵢ₋₁, C) for i=1, . . . , α, where detection schemes M₁, . . . , M_{α} are respectively learned from D₁, . . . , D_{α} using the defender's machine learning algorithm MLA (also known to the attacker). FIG. 11C depicts a full adaptation strategy in which the attacker sets the manipulated Dᵢ=F(Mᵢ₋₁, PP(D₀, . . . Dᵢ₋₁), C) for i=1, 2, . . . , where PP(•, . . . ) is a pre-processing algorithm for “aggregating” sets of feature vectors D₀, D₁, . . . into a single set of feature vectors, F is a manipulation algorithm, M₁, . . . , M_{α} are learned respectively from D₁, . . . , D_{α} by the attacker using the defender's machine learning algorithm MLA. Algorithm 2 is a concrete implementation of PP. Algorithm 5 is based on the idea that each malicious website corresponds to m malicious feature vectors that respectively belong to D₀, . . . , Dₘ₋₁, PP randomly picks one of the m malicious feature vectors to represent the malicious website in D.

Note that it is possible to derive some hybrid attack strategies from the above three basic strategies. Also it should be noted that the attack strategies and manipulation constraints are independent of the detection schemes, but manipulation algorithms would be specific to the detection schemes.

### Manipulation Constraints

There are three kinds of manipulation constraints. For a feature X whose value is to be manipulated, the attacker needs to compute X escape interval, which is a subset of feature X's domain domain(X) and can possibly cause the malicious feature vector to evade detection. Specifically, suppose features X₁, . . . , Xⱼ have been respectively manipulated to x₁, . . . , xⱼ (initially j=0), feature Xⱼ₊₁'s manipulated value is randomly chosen from its escapte_interval, which is calculated using Algorithm 6, while taking as input Xⱼ₊₁'s domain constraints, semantics constraints and correlation constraints and conditioned on X₁=x₁, . . . , Xⱼ=xⱼ.

Algorithm 6 Compute Xⱼ₊₁'s escape interval
Escape(Xⱼ₊₁, M, C, (X₁ = x₁, . . . , Xⱼ = xⱼ))

INPUT: Xⱼ₊₁ is feature for manipulation, M is detection scheme, C
represents constraints, Xⱼ₊₁ is correlated to X₁, . . . , Xⱼ whose values
have been respectively manipulated to x₁, . . . , xⱼ
OUTPUT: Xⱼ₊₁'s escape_interval

| | |
|---|---|
| 1: | domain_constraint ← C.domain_map(Xⱼ₊₁) |
| 2: | semantics_constraint ← C.domain_map(Xⱼ₊₁) { if Xⱼ₊₁ |
| | cannot be manipulate due to semantics constraints} |
| 3: | calculate correlation_constraint of Xⱼ₊₁ given X₁ = x₁, . . . , Xⱼ = |
| | xⱼ according to Eq. (1) |
| 4: | escape_interval ← domain_constraint ∩ semantics_constraint ∩ |
| | correlation_constraint |
| 5: | return escape_interval |

### Domain Constraints:

Each feature has its own domain of possible values. This means that the new value of a feature after manipulation must fall into the domain of the feature. Domain constraints are specified by the defender. Let C.domain_map be a table of (key, value) pairs, where key is feature name and value is the feature's domain constraint. Let C.domain_map(X) return feature X's domain as defined in C.domain_map.

### Semantics Constraints:

Some features cannot be manipulated at all. For example, Whois_country and Whois_stateProv of websites cannot be manipulated because they are bound to the website URLs, rather than the website contents. (The exception that the Whois system is compromised is assumed away here because it is orthogonal to the purpose of the present study). Moreover, the manipulation of feature values should have no side-effect to the attack, or at least cannot invalidate the attacks. For example, if a malicious website needs to use some script to launch the drive-by-download attack, the feature indicating the number of scripts in the website content cannot be manipulated to 0. Semantics constraints are also specified by the defender. Let C.semantics_map be a table of (key, value) pairs, where key is feature name and value is the feature's semantics constraints. Let C.semantics_map(X) return feature X's semantics constraints as specified in C.attack_map.

### Correlation Constraints:

Some features may be correlated to each other. This means that these features' values should not be manipulated independently of each other; otherwise, adaptive attacks can be defeated by simply examining the violation of correlations. In other words, when some features' values are manipulated; the correlated features' values should be accordingly manipulated as well. That is, feature values are manipulated either for evading detection or for maintaining the constraints. Correlation constraints can be automatically derived from data on demand (as done in our experiments), or alternatively given as input. Let C.group be a table of (key, value) pairs, where key is feature name and value records the feature's correlated features. Let C.group(X) return the set of features belonging to C.group, namely the features that are correlated to X.

Now we describe a method for maintaining correlation constraints, which is used in our experiments. Suppose D₀=D₀.malicious U D₀.benign is the input set of feature vectors, where the attacker knows D₀.malicious and attempts to manipulate the malicious feature vectors (representing malicious websites). Suppose the attacker already manipulated D₀ into Dᵢ and is about to manipulate Dᵢ into Dᵢ₊₁, where initial manipulation corresponds to i=0. Suppose X₁, . . . , Xₘ are some features that are strongly correlated to each other, where “strong” means that the Pearson correlation coefficient is greater than a threshold (e.g., 0.7). To accommodate the worst-case scenario, we assume that the threshold parameter is set by the defender and given to the attacker. It is natural and simple to identify and manipulate features one-by-one. Suppose without loss of generality that features X₁, . . . , Xⱼ (j<m) have been manipulated, where j=0 corresponds to the initial case, and that the attacker now needs to manipulate feature Xⱼ₊₁'s value. For this purpose, the attacker derives from data D′₀ a regression function:

Xⱼ₊₁=β₀+β₁X₁+ . . . +βⱼXⱼ+ε

for some unknown noise. Given (X₁, . . . , Xⱼ)=(x₁, . . . , xⱼ), the attacker can compute

\hat{x}ⱼ₊₁=β₀+β₁x₁+ . . . +βⱼxⱼ.

Suppose the attacker wants to maintain the correlation constraints with a confidence level θ (e.g., θ=0.85) that is known to the defender and the attacker (for accommodating the worst-case scenario), the attacker needs to compute Xⱼ₊₁'s correlation_interval:

[\hat{x}ⱼ₊₁−t_{δ/2}·s [symbol] ),\hat{x}ⱼ₊₁+t_{δ/2}·s [symbol] )], (1)

where δ=1−θ is the significance level for a given hypothesis test, t_{δ}/2 is a critical value (i.e., the area between t and −t is θ), s [symbol] )=s\sqrt{x′(X′X)⁻¹x} is the estimated standard error for xⱼ₊₁ with s being the sample standard deviation,

$$X = [ \begin{matrix}{x}_{1 , 1}^{0} & {x}_{1 , 2}^{0} & ⋯ & {x}_{1 , j}^{0} \\ {x}_{2 , 1}^{0} & {x}_{2 , 2}^{0} & ⋯ & {x}_{2 , j}^{0} \\ ⋮ & ⋮ & ⋱ & ⋮ \\ {x}_{n , 1}^{0} & {x}_{n , 2}^{0} & ⋯ & {x}_{n , j}^{0}\end{matrix} ] , x = [ \begin{matrix}{x}_{1} \\ {x}_{2} \\ ⋮ \\ {x}_{j}\end{matrix} ] ,$$

n being the sample size (i.e., the number of feature vectors in training data D′₀), x_{z,j}⁰ being feature Xⱼ's original value in the zth feature vector in training data D′₀ for 1≦z≦n, xⱼ being feature Xⱼ's new value in the feature vector in Dᵢ₊₁ (the manipulated version of Dᵢ), and X′ and x′ being respectively X's and x's transpose. Note that the above method assumes that the prediction error \hat{x}ⱼ₊₁−Xⱼ₊₁, rather than feature Xⱼ₊₁, follows the Gaussian distribution.

### Manipulation Algorithms

In an embodiment, the data-aggregation cross-layer J48 classifier method is adopted, where a J48 classifier is trained by concatenating the application- and network-layer data corresponding to the same URL. This method makes it much easier to deal with cross-layer correlations (i.e., some application-layer features are correlated to some network-layer features); whereas, the XOR-aggregation cross-layer method can cause complicated cascading side-effects when treating cross-layer correlations because the application and network layers have their own classifiers. Note that there is no simple mapping between the application-layer features and the network-layer features; otherwise, the network-layer data would not expose any useful information beyond what is already exposed by the application-layer data. Specifically, we present two manipulation algorithms, called F1 and F2, which exploit the defender's J48 classifier to guide the manipulation of features. Both algorithms neither manipulate the benign feature vectors (which are not controlled by the attacker), nor manipulate the malicious feature vectors that are already classified as benign by the defender's detection scheme (i.e., false-negative). Both algorithms may fail, while brute-forcing may fail as well because of the manipulation constraints.

The notations used in the algorithms are: for node υ in the classifier, υ.feature is the feature associated to node υ, and υ.value is υ.feature's “branching” value as specified by the classifier (a binary tree with all features numericalized). For feature vector fv, fv.feature.value denotes the value of feature in fv. The data structure keeps track of the features that are associated to the nodes in question, S.features is the set of features recorded in S, S.feature.value is the feature's value recorded in S, S.feature.interval is the feature's interval recorded in S, S.feature.manipulated=true means S.feature has been manipulated. A feature vector fv is actually manipulated according to S only when the manipulation can mislead M to misclassify the manipulated fv as benign.
Algorithm 7 describes manipulation algorithm F₁ (M, D, C), where M is a J48 classifier and D is a set of feature vectors, and C is the manipulation constraints. The basic idea is the following: For every malicious feature vector in D, there is a unique path (in the J48 classifier M) that leads to a malicious leaf, which indicates that the feature vector is malicious. We call the path leading to malicious leaf a malicious path, and the path leading to a benign leaf (which indicates a feature vector as benign) a benign path. By examining the path from the malicious leaf to the root, say malicious_leaf→ν₂→ . . . →root, and identifying the first inner node, namely ν₂, the algorithm attempts to manipulate fv.(ν2.feature).value so that the classification can lead to malicious_leaf's sibling, say υ_{2,another}_{_{—}}_{child}, which is guaranteed to exist (otherwise, υ₂ cannot be an inner node). Note that there must be a sub-path rooted at υ_{2,another}_{_{—}}_{child} that leads to a benign_leaf (otherwise, υ₂ cannot be an inner node as well), and that manipulation of values of the features corresponding to the nodes on the sub-tree rooted at υ_{2,another}_{_{—}}_{child} will preserve the postfix ν₂→ . . . →root. For each feature vector fvεD.malicious, the algorithm may successfully manipulate some features' values while calling Algorithm 8 to maintain constraints, or fail because the manipulations cannot be conducted without violating the constraints. The worst-case time complexity of F₁ is O(hlg), where h is the height of the J48 classifier, l is the number of features, and g is the size of the largest group of correlated features. The actual time complexity is very small. In our experiments on a laptop with Intel X3320 CPU and 8 GB RAM memory, F₁ takes 1.67 milliseconds to process a malicious feature vector on average over all malicious feature vectors and over 40 days.

Algorithm 7 Manipulation algorithm F₁ (M, D, C)

INPUT: J48 classifier M (binary decision tree), feature vector
set D = D.malicious ∪ D.benign, manipulation constraints C
OUTPUT: manipulated feature vectors

| | |
|---|---|
| 1: | for all feature vector fv ε D.malicious do |
| 2: | mani ← true; success ← false; S ← |
| 3: | v be the root node of M |
| 4: | while (mani == true) AND (success == false) do |
| 5: | if v is an inner node then |
| 6: | if fv.(v. feature).value ≦ v.value then |
| 7: | interval ← [min_{v.feature}, v.value] |
| 8: | else |
| 9: | interval ← (v.value, max_{v.feature} ] |
| 10: | end if |
| 11: | if [symbol] (v.feature, ·, ·, ·) ε S then |
| 12: | S ← S ∪ {(v.feature, |
| | fv.(v.feature).value, interval, false)} |
| 13: | else |
| 14: | S.(v.feature).interval ← interval ∩ |
| | S.(v.feature).interval |
| 15: | end if |
| 16: | v ← v's child as determined by v.value and |
| | fv.(v.feature).value |
| 17: | else if v is a malicious leaf then |
| 18: | v* ← v.parent |
| 19: | S* ← {s ε S : s.manipulated == true} |
| 20: | {X₁, . . . ,Xⱼ} ← C.group(v*. feature) ∩ S*. features, |
| | with values x₁, . . . ,xⱼ w.r.t. S* |
| 21: | esc_interval ← Escape(v*.feature, M, C, (X₁ = |
| | x₁, . . . , Xⱼ =xⱼ)) {call Algorithm 3} |
| 22: | if esc_interval == then |
| 23: | mani ← false |
| 24: | else |
| 25: | denote v*. feature by X {for shorter presentation} |
| 26: | S.X.interval ← (esc_interval ∩ S.X.interval) |
| 27: | S.X.value [symbol] S.X.interval |
| 28: | S.X.inanipulated ← true |
| 29: | v ← v's sibling |
| 30: | end if |
| 31: | else |
| 32: | success ← true {reaching a benign leaf} |
| 33: | end if |
| 34: | end while |
| 35: | if (mani == true) AND (success == true) AND |
| | (MR(M, C, S) == true) then |
| 36: | update fv's manipulated features according to S |
| 37: | end if |
| 38: | end for |
| 39: | return set of manipulated feature vectors D |

Algorithm 8 Maintaining constraints MR (M, C, S)

INPUT: J48 classifier M, manipulation constraints C, S =
{(feature, value, interval, manipulated)}
OUTPUT: true or false

| | |
|---|---|
| 1: | S* ← {s ε S : s.manipulated == true} |
| 2: | for all (feature, value, interval, true) ε S do |
| 3: | for all X ε C.group(feature) \ S*. features do |
| 4: | {X₁, . . . , Xⱼ} ← C.group(feature) ∩ S*. features, |
| | whose values are respectively x₁, . . . ,xⱼ w.r.t. S* |
| 5: | escape_interval ← Escape(feature, M, C, (X₁ = |
| | x₁, . . . ,Xⱼ = xⱼ)) |
| 6: | if escape_interval == then |
| 7: | return false |
| 8: | else |
| 9: | X.interval ← escape_interval |
| 10: | X.value [symbol] X.interval |
| 11: | S* ← S* ∪ {(X, X.value, X.interval, true)} |
| 12: | end if |
| 13: | end for |
| 14: | end for |
| 15: | return true |

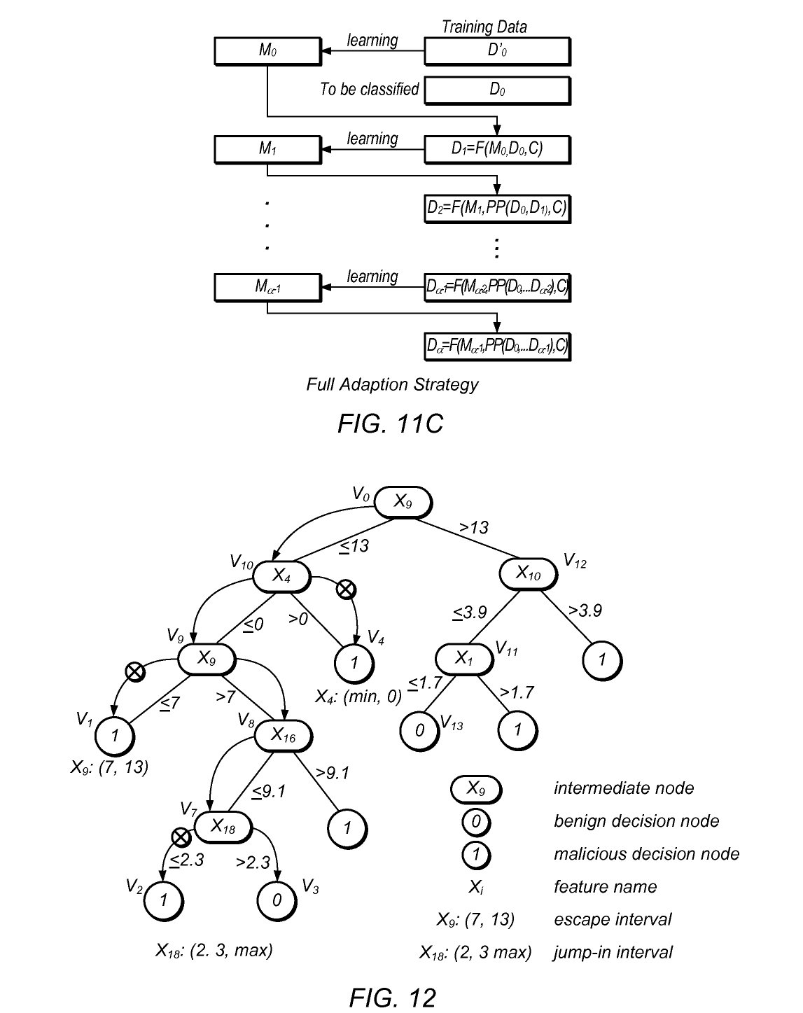

Now let us look at one example. At a high-level, the attacker runs AA(“J48”, M₀, D₀, ST, C, F₁, α=1) and therefore F₁ (M₀,D₀, C) to manipulate the feature vectors, where ST can be any of the three strategies because they cause no difference when α=1 (see FIG. 11 for a better exposition). Consider the example J48 classifier M in FIG. 12, where features and their values are for illustration purpose, and the leaves are decision nodes with class 0 indicating benign leaves and 1 indicating malicious leaves. For inner node υ₁₀ on the benign_path ending at benign_leaf υ₃, we have υ₁₀.feature=“X₄” and υ₁₀.feature.value=X₄.value. A website with feature vector:

(X₄=−1,X₉=5,X₁₆=5,X₁₈=5)

is classified as malicious because it leads to decision path

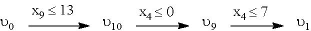

which ends at malicious leaf υ₁. The manipulation algorithm first identifies malicious leaf υ₁'s parent node υ₉, and manipulates X₉'s value to fit into υ₁'s sibling (υ₈). Note that X₉'s escape_interval is as:

([min₉,max₉]\[min₉,7])∩[min₉,13]=(7,13],

where Domain(X₉)=[min₉,max₉], [min₉, 7] corresponds to node υ9 on the path, and [min₀, 13] corresponds to node υ₀ on the path. The algorithm manipulates X₉'s value to be a random element from X₉'s escapte_interval, say 8ε(7, 13], which causes the manipulated feature vector to evade detection because of decision path:

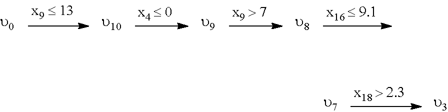

and ends at benign leaf υ₃. Assuming X₉ is not correlated to other features, the above manipulation is sufficient Manipulating multiple features and dealing with constraints will be demonstrated via an example scenario of running manipulation algorithm F2 below.

Algorithm 9 describes manipulation algorithm F₂ (M, D, C), where M is a J48 classifier and D is a set of feature vectors, and C is the manipulation constraints (as in Algorithm 7). The basic idea is to first extract all benign paths. For each feature vector fvεD.malicious, F2 keeps track of the mismatches between fv and a benign path (described by Pε′P) via an index structure

(mismatch,S={(feature,value,interval,manipulated)}),

where mismatch is the number of mismatches between fv and a benign path P, and S records the mismatches. For a feature vector fv that is classified by M as malicious, the algorithm attempts to manipulate as few “mismatched” features as possible to evade M

Algorithm 9 Manipulation algorithm F₂ (M, D, C)

INPUT: J48 classifier M, feature vectors D = D.malicious ∪
D.benign, constraints C
OUTPUT: manipulated feature vectors

| | |
|---|---|
| 1: | P ← {P ε P corresponds to a benign path} |
| 2: | for all benign leaf v do |
| 3: | P ← |
| 4: | while v, is not the root do |
| 5: | v ← v.parent |
| 6: | if [symbol] (v.feature, interval) ε P then |
| 7: | P ← P ∪ {(v. feature, v.interval)} |
| 8: | else |
| 9: | interval ← v.interval ∩ interval |
| 10: | end if |
| 11: | end while |
| 12: | P ← P ∪ {P} |
| 13: | end for |
| 14: | for all feature vector fv ε D.malicious do |
| 15: | S ← {record fv's mismatches w.r.t. all benign pathes} |
| 16: | for all P ε P do |
| 17: | (mismatch, S) ← (0, ) {S: mismatched feature set} |
| 18: | for all (feature, interval) ε P do |
| 19: | if fv.feature.value ∉ interval then |
| 20: | mismatch ← mismatch + 1 |
| 21: | S ← S ∪ {(feature, fv.feature.value, interval, false)} |
| 22: | end if |
| 23: | end for |
| 24: | S ← S ∪ {(mismatch, S)} |
| 25: | end for |
| 26: | sort (mismatch, S) ε S in ascending order of mismatch |
| 27: | attempt ← 1; mani ← true |
| 28: | while (attempt ≦ \|S\|) AND (mani == true) do |
| 29: | parse the attempt^{th} element (mismatch, S) of S |
| 30: | for all s = (feature, value, interval, false) ε S do |
| 31: | if mani == true then |
| 32: | S* ← {s ε S : s.manipulated == true} |
| 33: | {X₁, . . . ,Xⱼ} ← C.group(feature) ∩ S*, their values |
| | are respectively x₁ , . . . , xⱼ w.r.t. S* |
| 34: | escape_interval ← Escape(feature, M, C, |
| | (X₁ = x₁, . . . , Xⱼ = xⱼ)) {call Algorithm 3} |
| 35: | if escape_interval ∩ S. feature.interval ≠ then |
| 36: | S. feature.interval ← (S. feature.interval ∩ |
| | escape_interval) |
| 37: | S. feature.value [symbol] S. feature.interval |
| 38: | S. feature.manipulated ← true |
| 39: | else |
| 40: | mani ← false |
| 41: | end if |
| 42: | end if |
| 43: | end for |
| 44: | if (mani == false) OR (MR(M, C, S) == false) then |
| 45: | attempt ← attempt + 1; mani ← true |
| 46: | else |
| 47: | update fv's manipulated features according to S |
| 48: | mani ← false |
| 49: | end if |
| 50: | end while |
| 51: | end for |
| 52: | return manipulated feature vectors D |

After manipulating the mismatched features, the algorithm maintains the constraints on the other correlated features by calling Algorithm 8. Algorithm 9 incurs O(ml) space complexity and O(hlgm) time complexity where m is the number of benign paths in a classifier, l is the number of features, h is the height of the J48 classifier and g is the size of the largest group of correlated features. In our experiments on the same laptop with Intel X3320 CPU and 8 GB RAM memory, F₂ takes 8.18 milliseconds to process a malicious feature vector on average over all malicious feature vectors and over 40 days.

To help understand Algorithm 9, let us look at another example also related to FIG. 12. Consider feature vector:

(X₄=0.3,X₉=5.3,X₁₆=7.9,X₁₈=2.1,X₁₀=3,X₁=2.3),

which is classified as malicious because of path

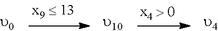

To evade detection, the attacker can compare the feature vector to the matrix of two benign paths. For the benign path υ₃→υ₇→υ₈→υ₉→υ₁₀→υ₀, the feature vector has three mismatches, namely features X₄, X₉, X₁₈. For the benign path v13→v11→v12→v0, the feature vector has two mismatches, namely X₉ and X₁. The algorithm first processes the benign path ending at node υ₁₃. For the benign path ending at node υ₁₃, the algorithm manipulates X₉ to a random value in [13,max₉] (say 17), and manipulates X₁ to a random value in X₁.interval=[min₁, 1.7] (say 1.4). Suppose X₉, X₁₀, X₁ are strongly correlated to each other, the algorithm further calculates X₁₀'s escape interval according to Eq. (1) while considering the constraint X₁₀ε[min₁₀, 3.9] (see node υ₁₂). Suppose X₁₀ is manipulated to 3.5 after accommodating the correlation constraints. In this scenario, the manipulated feature vector is

(X₄=0.3,X₉=17,X₁₆=7.9,X₁₈=2.1,X₁₀=3.5,X₁=1.4),

which is classified as benign because of path

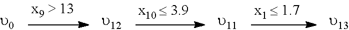

Suppose on the other hand, that X₁₀ cannot be manipulated to a value in [min₁₀, 3.9] without violating the constraints. The algorithm stops with this benign path and considers the benign path end at node υ₃. If the algorithm fails with this benign path again, the algorithm will not manipulate the feature vector and leave it to be classified as malicious by defender's J48 classifier M.

### Power of Adaptive Attacks

In order to evaluate the power of adaptive attacks, we evaluate M₀(D₁), where M₀ is learned from D′₀ and D₁ is the output of adaptive attack algorithm AA. Our experiments are based on a 40-day dataset, where for each day: D′₀ consists of 340-722 malicious websites (with mean 571) as well as 2,231-2,243 benign websites (with mean 2,237); D₀ consists of 246-310 malicious websites (with mean 282) as well as 1,124-1,131 benign websites (with mean 1,127). We focus on the data-aggregation cross-layer method, while considering single-layer (i.e., application and network) method for comparison purpose. We first highlight some manipulation constraints that are enforced in our experiments.

### Domain Constraints:

The length of URLs (URL_length) cannot be arbitrarily manipulated because it must include hostname, protocol name, domain name and directories. Similarly, the length of webpage content (Content_length) cannot be arbitrarily short.

### Correlation Constraints:

There are four groups of application-layer features that are strongly correlated to each other; there are three groups of network-layer features that are strongly correlated to each other; there are three groups of features that formulate cross-layer constraints. One group of cross-layer correlation is: the application-layer website content length (#Content_length) and the network-layer duration time (Duration). This is because the bigger the content, the longer the fetching time. Another group of cross-layer correlations is: the application-layer number of redirects (#Redirect), the network-layer number of DNS queries (#DNS_query), and the network-layer number of DNS answers (#DNS_answer). This is because more redirects leads to more DNS queries and more DNS answers.

### Semantics Constraints:

Assuming the Whois system is not compromised, the following features cannot be manipulated: website registration date (RegDate), website registration state/province (Stateprov), website registration postal code (Postalcode), and website registration country (Country). For malicious websites that use some scripts to launch the drive-by-download attack, the number of scripts contained in the webpage contents (#Scripts) cannot be 0. The application-layer protocol feature (Protocol) may not be arbitrarily changed (e.g., from ftp to http).

TABLE 1

| | F₁ | | | F₂ | | |
|---|---|---|---|---|---|---|
| | FN | #MF | FA | FN | #MF | FA |
| network-layer | 94.7% | 4.31 | 5.8% | 95.3% | 4.01 | 5.1% |
| application-layer | 91.9% | 6.01 | 8.6% | 93.3% | 5.23 | 7.1% |
| data-agg. cross-layer | 87.6% | 7.23 | 12.6% | 89.1% | 6.19 | 11.0% |

Table 1 summarizes the results of adaptive attack AA(“J48”, M₀, D₀, ST, C, F, α=1) based on the 40-day dataset mentioned above, where C accommodates the constraints mentioned above. Experiment results are shown in Table 1 with M₀(D₁) in terms of average false-negative rate (FN), average number of manipulated features (#MF), average percentage of failed attempts (FA), where “average” is over the 40 days of the dataset. The experiment can be more succinctly represented as M₀(D₁), meaning that the defender is static (or non-proactive) and the attacker is adaptive with α=1, where D₁ is the manipulated version of D₀. Note that in the case of α=1, the three adaptation strategies lead to the same D₁ as shown in FIG. 11. From Table 1, we make the following observations. First, both manipulation algorithms can effectively evade detection by manipulating on average 4.31-7.23 features while achieving false-negative rate 87.6%-94.7% for F₁, and by manipulating on average 4.01-6.19 features while achieving false-negative rate 89.1%-95.3% for F₂. For the three J48 classifiers based on different kinds of D₀ (i.e., network-layer data alone, application-layer data alone and cross-layer data-aggregation), F₂ almost always slightly outperforms F₁ in terms of false-negative rate (FN), average number of manipulated features (#MF), and average percentage of failed attempts at manipulating feature vectors (FA). Second, data-aggregation cross-layer classifiers are more resilient against adaptive attacks than network-layer classifiers as well as application-layer classifiers.
Which features are often manipulated for evasion? We notice that many features are manipulated over the 40 days, but only a few are manipulated often. For application-layer alone, F₁ most often (i.e., >150 times each day for over the 40 days) manipulates the following five application-layer features: URL_length (URL_length), number of scripts contained in website content (#Script), webpage length (Content_length), number of URLs embedded into the website contents (#Embedded_URL), and number of Iframes contained in the webpage content (#Iframe). In contrast, F₂ most often (i.e., >150 times) manipulates the following three application-layer features: number of special characters contained in URL (#Special_character), number of long strings (#Long_strings) and webpage content length (Content_length). That is, Content_length is the only feature that is most often manipulated by both algorithms.
For network-layer alone, F₁ most often (i.e., >150 times) manipulates the following three features: number of remote IP addresses (#Dist_remote_IP), duration time (Duration), and number of application packets (#Local_app_packet). Whereas, F₂ most often (i.e., >150 times) manipulates the distinct number of TCP ports used by the remote servers (#Dist_remote_TCP_port). In other words, no single feature is often manipulated by both algorithms.

For data-aggregation cross-layer detection, F₁ most often (i.e., >150 times each day for over the 40 days) manipulates three application layer features—URL length (URL_length), webpage length (Content_length), number of URLs embedded into the website contents (#Embedded_URLs)—and two network-layer features—duration time (Duration) and number of application packets (#Local_app_packet). On the other hand, F₂ most often (i.e., >150 times) manipulates two application-layer features—number of special characters contained in URL (#Special_characters) and webpage content length (Content_length)—and one network-layer feature—duration time (Duration). Therefore, Content_length and Duration are most often manipulated by both algorithms.

The above discrepancy between the frequencies that features are manipulated can be attributed to the design of the manipulation algorithms. Specifically, F₁ seeks to manipulate features that are associated to nodes that are close to the leaves. In contrast, F₂ emphasizes on the mismatches between a malicious feature vector and an entire benign path, which represents a kind of global search and also explains why F₂ manipulates fewer features.

Having identified the features that are often manipulated, the next natural question is: Why them? Or: Are they some kind of “important” features? It would be ideal if we can directly answer this question by looking into the most-often manipulated features. Unfortunately, this is a difficult problem because J48 classifiers (or most, if not all, detection schemes based on machine learning), are learned in a black-box (rather than white-box) fashion. As an alternative, we compare the manipulated features to the features that would be selected by a feature selection algorithm for the purpose of training classifiers. To be specific, we use the InfoGain feature selection algorithm because it ranks the contributions of individual features. We find that among the manipulated features, URL_length is the only feature among the five InfoGain-selected application-layer features, and #Dist_remote_TCP_port is the only feature among the four InfoGain-selected network-layer features. This suggests that the feature selection algorithm does not necessarily offer good insights into the importance of features from a security perspective. To confirm this, we further conduct the following experiment by additionally treating InfoGain-selected top features as semantics constraints in C (i.e., they cannot be manipulated). Table 2 (counterparting Table 1) summarizes the new experiment results. By comparing the two tables, we observe that there is no significant difference between them, especially for manipulation algorithm F₂. This means that InfoGain-selected features have little security significance.

TABLE 2

| | F₁ | | | F₂ | | |
|---|---|---|---|---|---|---|
| | FN | #MF | FA | FN | #MF | FA |
| network-layer | 93.1% | 4.29 | 7.5% | 95.3% | 4.07 | 5.1% |
| application-layer | 91.3% | 6.00 | 9.2% | 93.3% | 5.28 | 7.1% |
| data-aggregation | 87.4% | 7.22 | 12.7% | 89.1% | 6.23 | 11.0% |

In order to know whether or not the adaptive attack algorithm AA actually manipulated some “important” features, we conduct an experiments by setting the most-often manipulated features as non-manipulatable. The features that are originally identified by F1 and then set as nonmanipulatable are: webpage length (content_length), number of URLs that are embedded into the website contents (#Embedded_URLs), number of redirects (#Redirect), number of distinct TCP ports that are used by the remote webservers (Dist_remote_tcp_port), and number of application-layer packets (Local_app_packets). Table 3 summarizes the results. When compared with Tables 1-2, we see that the false-negative rate caused by adaptive attacks drops substantially: from about 90% down to about 60% for manipulation algorithm F₁, and from about 90% down to about 80% for manipulation algorithm F₂. This means perhaps that the features that are originally identified by F₁ are more indicative of malicious websites than the features that are originally identified by F₂. Moreover, we note that no feature is manipulated more than 150 times and only two features—#Iframe (the number of iframes) and #DNS_query (the number of DNS_query) are manipulated more than 120 times by F₁ and one feature—#JS_function (the number of JavaScript functions)—is manipulated more than 120 times by F₂.

TABLE 3

| | F₁ | | | F₂ | | |
|---|---|---|---|---|---|---|
| | FN | #MF | FA | FN | #MF | FA |
| network-layer | 62.1% | 5.88 | 41.6% | 80.3% | 5.07 | 21.6% |
| application-layer | 68.3% | 8.03 | 33.7% | 81.1% | 6.08 | 20.1% |
| data-aggregation | 59.4% | 11.13 | 41.0% | 78.7% | 7.83 | 21.5% |

Proactive Detection Vs. Adaptive Attacks

We have showed that adaptive attacks can ruin the defender's (nonproactive) detection schemes. Now we investigate how the defender can exploit proactive detection against adaptive attacks We propose that the defender can run the same kinds of manipulation algorithms to proactively anticipate the attacker's adaptive attacks.

### Proactive Detection Model and Algorithm

Algorithm 10 Proactive detection PD (MLA, M₀, D₀^{†}, D_{α}, ST_{D}, C, F_{D, γ})

INPUT: M₀ is learned from D₀^{′} using machine learning algorithm MLA,
D₀^{†} = D₀^{†}.benign ∪ D₀^{†}.malicious, D_{α} (α unknown to defender) is set of
feature vectors (with D_{α}.malicious possibly manipulated by the attacker),
ST_{D} is defender's adaptation strategy, F_{D} is defender's manipulation
algorithm, C is set of constraints, γ is defender's number of adaptation
rounds
OUTPUT: malicious vectors fv ε D_{α}

| | |
|---|---|
| 1: | M₁^{†}, . . . , M_{γ}^{†} ← PT(MLA, M₀, D₀^{†}, ST_{D}, C, F_{D, γ}) (see Algorithm |
| | 8} |
| 2: | malicious ← |
| 3: | for all fv ε D_{α} do |
| 4: | if (M₀ (fv) says fv is malicious) OR (majority of |
| | M₀(fv), M₁^{†} (fv), . . . , M_{γ}^{†}(fv) say fv is malicious) then |
| 5: | malicious ← malicious ∪ {fv} |
| 6: | end if |
| 7: | end for |
| 8: | return malicious |

Proactive detection PD (MLA, M₀, D₀^{†}, D_{α}, ST_{D}, C, F_{D,γ}) is described as Algorithm 10, which calls as a sub-routine the proactive training algorithm PT described in Algorithm 11 (which is similar to, but different from, the adaptive attack algorithm AA).

Algorithm 11 Proactive training PT(MLA, M₀, D₀^{†}, ST_{D}, C, F_{D, γ})

INPUT same as Algorithm 10
OUTPUT: M₁^{†}, . . . , \check{M}_{γ}^{†}

| | |
|---|---|
| 1: | M₀^{†} ← M₀ {for simplifying notations} |
| 2: | initialize D₁^{†}, . . . , D_{γ}^{†} and M₁^{†}, . . . , M_{γ}^{†} |
| 3: | for i=to γ do |
| 4: | if ST_{D} == parallel-adaptation then |
| 5: | Dᵢ^{†}.malicious ← F_{D}(M₀^{†}, D₀^{†}.malicious, C) |
| 6: | else if ST_{D} == sequential-adaptation then |
| 7: | Dᵢ^{†}.malicious ← F_{D}(Mᵢ₋₁^{†}, Dᵢ₋₁^{†}.malicious , C) |
| 8: | else if ST_{D} == full-adaptation then |
| 9: | Dᵢ₋₁^{†}.malicious ← PP(D₀^{†}, . . . , Dᵢ₋₂^{†}) |
| 10: | Dᵢ^{†}.malicious ← F_{D} (Mᵢ₋₁^{†}, Dᵢ₋₁^{†}, C) |
| 11: | end if |
| 12: | Dᵢ^{†}.benign ← D₀^{†}.benign |
| 13: | Mᵢ^{†} ← MLA(Dᵢ^{†}) |
| 14: | end for |
| 15: | return M₁^{†}, . . . , M_{γ}^{†} |

Specifically, PT aims to derive detection schemes M₁^{†}, . . . , M_{γ}^{†}, from the starting-point detection scheme M₀. Since the defender does not know a priori whether the attacker is adaptive or not (i.e., α>0 vs. α=0), PD deals with this uncertainty by first applying M₀, which can deal with D₀ effectively. If M₀ says that a feature vector fvεD_{α} is malicious, fv is deemed malicious; otherwise, a majority voting is made between M₀ (fv), M₁^{†}(fv), . . . , M_{γ}^{†}(fv).

### Evaluation and Results

To evaluate proactive detection PD's effectiveness, we use Algorithm 12 and the metrics defined above: detection accuracy (ACC), true-positive rate (TP), false-negative rate (FN), and false-positive rate (FP). Note that TP=1−FN, but we still list both for easing the discussion. When the other parameters are clear from the context, we use M_{0-γ}(D_{α}) to stand for Eva(MLA, M₀, D₀^{†}, D₀, ST_{A}, F_{A}, ST_{D}, F_{D}, C, α, γ). For each of the 40 days mentioned above, the data for proactive training, namely D₀^{†}, consists of 333-719 malicious websites (with mean 575) and 2,236-2,241 benign websites (with mean 2,238).

The parameter space of Eva includes at least 108 scenarios: the basic adaptation strategy space ST_{A}×ST_{D} is 3×3 (i.e., not counting any hybrids of parallel-adaptation, sequential-adaptation and full-adaptation), the manipulation algorithm space F_{A}×F_{B} is 2×2, and the adaptation round parameter space is at least 3 (α>, =, <γ). Since the data-aggregation cross-layer detection significantly outperforms the single layer detections against non-adaptive attacks and is more resilient than the single layer detections against adaptive attacks as shown in Section 3.2, in what follows we focus on data-aggregation cross-layer detection. For the baseline case of nonproactive detection against non-adaptive attack, namely M₀(D₀), we have average ACC=99.68% (detection accuracy), TP=99.21% (true-positive rate), FN=0.79% (false-negative rate) and FP=0.14% (false-positive rate), where “average” is over the 40 days corresponding to the dataset. This baseline result also confirms the conclusion that data-aggregation cross-layer detection can be used in practice.

Table 4 summarizes the effectiveness of proactive detection against adaptive attacks. We make the following observations. First, if the defender is proactive (i.e., γ>0) but the attacker is non-adaptive (i.e., α=0), the false-negative rate drops from 0.79% in the baseline case to some number belonging to interval [0.23%, 0.56%].

Algorithm 12 Proactive detection vs. adaptive attack evaluation
Eva(MLA, M₀, D₀^{†}, D₀, ST_{A}, F_{A}, ST_{D}, F_{D}, C, α, γ)

INPUT: detection scheme M₀ (learned from D₀^{′}, which is omitted), D₀^{†} is
set of feature vectors for defender's proactive training, D₀ = D₀.malicious ∪
D₀.benign, ST_{A} (ST_{D}) is attacker's (defender's) adaptation strategy, F_{A}
(F_{D}) is attacker's (defender's) manipulation algorithm, C is the constraints,
α (γ) is the number of attacker's (defender's) adaptation rounds
OUTPUT: ACC, FN, TP and FP

| | |
|---|---|
| 1: | if α > 0 then |
| 2: | D_α ← AA(MLA, M₀, D₀ ,ST_{A}, C, F_{A}, α) |
| | {call Algorithm 1} |
| 3: | end if |
| 4: | M₁^{†}, . . . , M_{γ}^{†} ← PT(MLA, M₀, D₀^{†}, ST_{D}, C, F_{D}, γ) |
| | {call Algorithm 8} |
| 5: | malicious ← PD(MLA, M₀, D₀^{†} ,D_{α}, ST_{D}, C, F_{D}, γ) |
| | {call Algorithm 7} |
| 6: | benign ← D_{α} \ malicious |
| 7: | calculate ACC, FN, TP and FP w.r.t. D₀ |
| 8: | return ACC, FN, TP and FP |

The price is: the detection accuracy drops from 99.68% in the baseline case to some number belonging to interval [99.23%, 99.68%] the false-positive rate increases from 0.14% in the baseline case to some number belonging to interval [0.20%, 0.93%], and the proactive detection algorithm PD's running time is now (γ+1) times of the baseline case because of running M₀(D_{α}), M₁^{†}((D_{α}), . . . , M_{γ}^{†}((D_{α}), which takes on average 0.54(γ+1) milliseconds to process a feature vector. Note that the running time of the proactive training algorithm PT is also (γ+1) times of the baseline training algorithm. This can be reasonably ignored because the defender only runs the training algorithms once a day. The above observations suggest: the defender can always use proactive detection without worrying about side-effects (e.g., when the attacker is not adaptive). This is because the proactive detection algorithm PD uses M₀(D₀) as the first line of detection.

Second, when ST_{A}=ST_{D} (meaning α>0 and γ>0), it has a significant impact whether or not they use the same manipulation algorithm. Specifically, proactive detection in the case of F_{D}=F_{A} is more effective than in the case of F_{D}≠F_{A}. This phenomenon also can be explained by that the features that are often manipulated by F₁ are very different from the features that are often manipulated by F₂. More specifically, when F_{A}=F_{D}, the proactively learned classifiers M₁^{†}, . . . , M_{γ}^{†}, would capture the “maliciousness” information embedded in the manipulated data D_{α}; this would not be true when F_{A}≠F_{D}. Moreover, the sequential adaptation strategy appears to be more “oblivious” than the other two strategies in the sense that D_{α} preserves less information about D₀. This may explain why the false-negative rates when ST_{A}=ST_{D}=sequential can be respectively substantially higher than their counterparts when ST_{A}=ST_{D}≠sequential. The above discussions suggest the following: If the attacker is using ST_{A}=sequential, the defender should not use ST_{D}=sequential.

Third, what adaptation strategy should the defender use to counter ST_{A}=sequential? Table 5 shows that the defender should use ST_{D}=full because it leads to relatively high detection accuracy and relatively low false-negative rate, while the false-positive rate is comparable to the other cases. Even if the attacker knows that the defender is using ST_{D}=full, Table 5 shows that the attacker does not have an obviously more effective counter adaptation strategy. This hints that the full strategy (or some variant of it) may be a kind of equilibrium strategy because both attacker and defender have no significant gains by deviating from it. This inspires an important problem for future research is the full adaptation strategy (or variant of it) an equilibrium strategy?

TABLE 4

| | Manipulation | M₀₋₈(D₀) | | | | M₀₋₈(D₁) | | | | M₀₋₈(D₉) | | | |
|---|---|---|---|---|---|---|---|---|---|---|---|---|---|
| Strategy | algorithm | ACC | TP | FN | FP | ACC | TP | FN | FP | ACC | TP | FN | FP |
| ST_{A} = ST_{D} = | F_{D} = F₁ vs. F_{A} = F₁ | 99.59 | 99.71 | 0.29 | 0.39 | 95.58 | 92.03 | 7.97 | 3.62 | 95.39 | 92.00 | 8.00 | 3.83 |
| parallel | F_{D} = F₁ vs. F_{A} = F₂ | 99.27 | 99.77 | 0.23 | 0.77 | 78.51 | 25.50 | 74.50 | 9.88 | 78.11 | 32.18 | 67.82 | 11.48 |
| | F_{D} = F₂ vs. F_{A} = F₁ | 99.16 | 99.76 | 0.24 | 0.93 | 76.33 | 19.32 | 80.68 | 11.17 | 78.96 | 39.77 | 60.23 | 12.14 |
| | F_{D} = F₂ vs. F_{A} = F₂ | 99.59 | 99.62 | 0.38 | 0.39 | 93.66 | 90.25 | 9.75 | 5.59 | 96.17 | 92.77 | 7.23 | 3.08 |
| ST_{A} = ST_{D} = | F_{D} = F₁ vs. F_{A} = F₁ | 99.52 | 99.69 | 0.31 | 0.45 | 93.44 | 77.48 | 22.52 | 3.05 | 92.04 | 59.33 | 30.67 | 2.99 |
| sequential | F_{D} = F₁ vs. F_{A} = F₂ | 99.23 | 99.70 | 0.30 | 0.82 | 74.24 | 20.88 | 79.22 | 14.06 | 79.43 | 30.03 | 69.97 | 9.38 |
| | F_{D} = F₂ vs. F_{A} = F₁ | 99.27 | 99.67 | 0.33 | 0.80 | 77.14 | 29.03 | 70.97 | 12.33 | 82.72 | 40.93 | 59.07 | 7.83 |
| | F_{D} = F₂ vs. F_{A} = F₂ | 99.52 | 99.53 | 0.47 | 0.50 | 93.44 | 78.70 | 21.30 | 2.10 | 92.04 | 62.30 | 37.70 | 2.11 |
| | F_{D} = F₁ vs. F_{A} = F₁ | 99.68 | 99.44 | 0.56 | 0.20 | 96.92 | 96.32 | 3.68 | 2.89 | 95.73 | 92.03 | 7.97 | 3.27 |
| ST_{A} = ST_{D} = | F_{D} = F₁ vs. F_{A} = F₂ | 99.27 | 99.58 | 0.42 | 0.72 | 85.68 | 40.32 | 59.68 | 4.38 | 78.11 | 29.99 | 70.01 | 11.00 |
| full | F_{D} = F₂ vs. F_{A} = F₁ | 99.60 | 99.66 | 0.34 | 0.40 | 85.65 | 51.84 | 48.16 | 6.93 | 87.61 | 72.99 | 27.01 | 9.01 |
| | F_{D} = F₂ vs. F_{A} = F₂ | 99.68 | 99.60 | 0.40 | 0.28 | 96.92 | 95.60 | 4.40 | 2.88 | 95.73 | 90.09 | 9.91 | 2.83 |

TABLE 5

| ST_{D} vs. | | STA = parallel | | | | STA = sequential | | | | STA = full | | | |
|---|---|---|---|---|---|---|---|---|---|---|---|---|---|
| ST_{A} | M_{0-γ}(D_{α}) | ACC | TP | FN | FP | ACC | TP | FN | FP | ACC | TP | FN | FP |

Manipulation algorithm F_{D} = F_{A} = F₁

| | | | | | | | | | | | | | |
|---|---|---|---|---|---|---|---|---|---|---|---|---|---|
| ST_{D} = | M₀₋₈(D₁) | 95.58 | 92.03 | 7.97 | 3.62 | 94.25 | 90.89 | 9.11 | 4.96 | 94.91 | 92.08 | 7.92 | 4.32 |
| parallel | M₀₋₈(D₉) | 95.39 | 92.00 | 8.00 | 3.83 | 92.38 | 80.03 | 19.97 | 4.89 | 93.19 | 84.32 | 15.68 | 4.54 |
| ST_{D} = | M₀₋₈(D₁) | 92.15 | 74.22 | 25.78 | 3.93 | 93.44 | 77.48 | 22.52 | 3.05 | 92.79 | 76.32 | 23.68 | 3.07 |
| sequential | M₀₋₈(D₉) | 89.20 | 58.39 | 41.61 | 4.11 | 92.04 | 59.33 | 30.67 | 2.99 | 88.42 | 57.89 | 42.11 | 3.91 |
| ST_{D} = | M₀₋₈(D₁) | 96.24 | 94.98 | 5.02 | 3.42 | 96.46 | 94.99 | 5.01 | 3.15 | 96.92 | 96.32 | 3.68 | 2.89 |
| full | M₀₋₈(D₉) | 94.73 | 90.01 | 9.99 | 4.21 | 94.70 | 90.03 | 9.97 | 4.23 | 95.73 | 92.03 | 7.97 | 3.27 |

Manipulation algorithm F_{D} = F_{A} = F₂

| | | | | | | | | | | | | | |
|---|---|---|---|---|---|---|---|---|---|---|---|---|---|
| ST_{D} = | M₀₋₈(D₁) | 93.66 | 90.25 | 9.75 | 5.59 | 94.25 | 88.91 | 11.09 | 3.98 | 94.91 | 89.77 | 10.23 | 3.53 |
| parallel | M₀₋₈(D₉) | 96.17 | 92.77 | 7.23 | 3.08 | 92.38 | 77.89 | 22.11 | 4.32 | 93.19 | 81.32 | 18.68 | 3.38 |
| ST_{A} = | M₀₋₈(D₁) | 90.86 | 70.98 | 29.02 | 4.82 | 93.44 | 78.70 | 21.30 | 2.10 | 92.79 | 72.32 | 27.68 | 4.02 |
| sequential | M₀₋₈(D₉) | 88.43 | 53.32 | 46.68 | 3.97 | 92.04 | 62.30 | 37.70 | 2.11 | 88.42 | 57.88 | 42.12 | 3.17 |
| ST_{A} = | M₀₋₈(D₁) | 95.69 | 93.89 | 6.11 | 3.88 | 96.46 | 94.98 | 5.02 | 3.03 | 96.92 | 95.60 | 4.40 | 2.88 |
| full | M₀₋₈(D₉) | 96.06 | 91.46 | 8.54 | 2.89 | 94.70 | 90.99 | 9.01 | 2.32 | 95.73 | 90.09 | 9.91 | 2.83 |

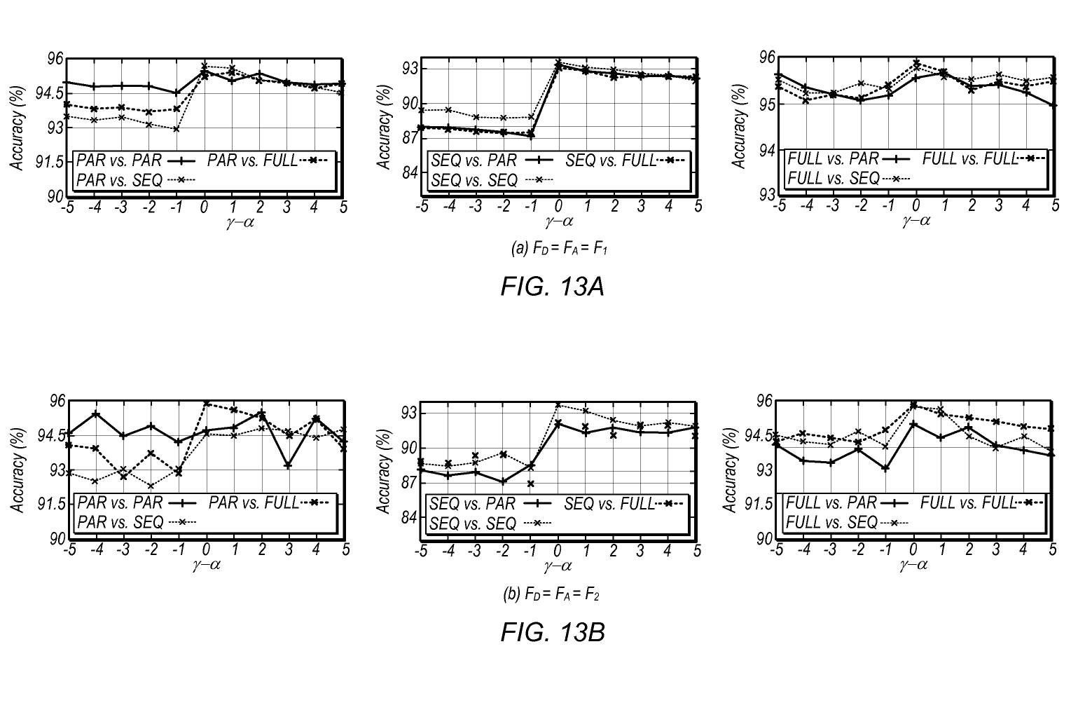

Fourth, Table 4 shows that when ST_{D}=ST_{A}, the attacker can benefit by increasing its adaptiveness (i.e., increasing α). Table 5 exhibits the same phenomenon when ST_{D}≠ST_{A}. On the other hand, by comparing Tables 4-5 and Table 1, it is clear that proactive detection M_{0-γ}(D_{α}) for γ>0 is much more effective than non-proactive detection M₀(D_{α}) for γ=0. FIG. 13 depicts a plot of the detection accuracy with respect to (γ−α) under the condition F_{D}=F_{A} and under various ST_{D}×ST_{A} combinations in order to see the impact of defender's proactiveness (as reflected by γ) against the defender's adaptiveness (as reflected by α). We observe that roughly speaking, as the defender's proactiveness (γ) increases to exceed the attacker's adaptiveness (α) (i.e., γ changes from γ<α to γ=α to γ>α), the detection accuracy may have a significant increase at γ−α=0. Moreover, we observe that when ST_{D}=full, γ−α has no significant impact on the detection accuracy. This suggests that the defender should always use the full adaptation strategy to alleviate the uncertainty about the attacker's adaptiveness α.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A computer-implemented method for detecting malicious websites, comprising:
collecting data from a website, wherein the collected data comprises:
application-layer data of a URL, wherein the application-layer data is in the form of feature vectors; and
network-layer data of a URL, wherein the network-layer data is in the form of feature vectors; and
determining if a website is malicious based on the collected application-layer data vectors and the collected network-layer data vectors.

2. The method of claim 1, wherein the application layer data comprises application layer communications of URL contents, and where the network layer data comprises network-layer traffic resulting from the application layer communications.

3. The method of claim 1, wherein collecting data from the website comprises automatically fetching the website contents by launching HTTP/HTTPS requests to a targeted URL, and tracking redirects identified from the website contents.

4. The method of claim 1, wherein determining if a website is malicious comprises analyzing a selected subset of the collected application-layer data vectors and the collected network-layer data vectors.

5. The method of claim 1, wherein determining if a website is malicious comprises merging collected application-layer data vectors with corresponding collected network-layer data vectors into a single vector.

6. The method of claim 1, wherein a website is determined to be malicious if one or more of the application-layer data vectors or one or more of the collected network-layer data vectors indicate that the website is malicious.

7. The method of claim 1, wherein a website is determined to be malicious if one or more of the application-layer data vectors and one or more of the collected network-layer data vectors indicate that the website is malicious.

8. The method of claim 1, further comprising:
determining if the collected application-layer data and/or network-layer data vectors have been manipulated.

9. A system, comprising:
a processor;
a memory coupled to the processor and configured to store program instructions executable by the processor to implement the method comprising:
collecting data from a website, wherein the collected data comprises:
application-layer data of a URL, wherein the application-layer data is in the form of feature vectors; and
network-layer data of a URL, wherein the network-layer data is in the form of feature vectors; and
determining if a website is malicious based on the collected application-layer data vectors and the collected network-layer data vectors.

10. A tangible, computer readable medium comprising program instructions, wherein the program instructions are computer-executable to implement the method comprising:
collecting data from a website, wherein the collected data comprises:
application-layer data of a URL, wherein the application-layer data is in the form of feature vectors; and
network-layer data of a URL, wherein the network-layer data is in the form of feature vectors; and
determining if a website is malicious based on the collected application-layer data vectors and the collected network-layer data vectors.

11. (canceled)
